(19) United States
(12) Patent Application Publication
(10) Pub. No.: US 2026/0332229 A1
(43) Pub. Date: Oct. 22, 2026

(54) TECHNIQUES FOR BEAM MANAGEMENT USING MODEL ADAPTATION

(71) Applicant: QUALCOMM Incorporated, San Diego, CA (US)

(72) Inventors: Yuwei REN, Beijing (CN); Tianyang BAI, Somerville, NJ (US)

(21) Appl. No.: 19/114,762

(22) PCT Filed: Nov. 30, 2022
(86) PCT No.: PCT/CN2022/135228

§ 371 Date: Mar. 24, 2025

(51) Int. Cl. H04B 7/06; H04B 17/318; H04L 41/16

(52) U.S. Cl. CPC H04B 7/06952; H04B 17/328; H04L 41/16

(57) ABSTRACT

Methods, systems, and devices for wireless communications are described. A user equipment (UE) may be configured to receive, from a network entity, control signaling indicating a machine learning model to be used for beam prediction at the UE, the control signaling further indicating one or more thresholds for reporting outputs from the machine learning model. The UE may perform a first set of measurements on a set of reference signals received from the network entity, and predict a first set of beam quality metrics associated with a set of receive beams at the UE based on inputting the first set of measurements into the machine learning model. The UE may then transmit, to the network entity, a control message indicating the first set of measurements based on the first set of beam quality metrics satisfying the one or more thresholds.

### CROSS REFERENCE

This application is a 371 National Stage of PCT Application No. PCT/CN2022/135228, filed on Nov. 30, 2022, entitled “TECHNIQUES FOR BEAM MANAGEMENT USING MODEL ADAPTATION”, and assigned to the assignee hereof. The disclosure of the prior Application is considered part of and is incorporated by reference into this Patent Application.

### FIELD OF TECHNOLOGY

The following relates to wireless communications, including techniques for beam management using model adaptation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless devices (e.g., UEs) may be configured to perform measurements on reference signals from the network and input the measurements into a machine learning algorithm to predict relative qualities of receive (Rx) beams that should be used for future communications. Machine learning models may not be able to adapt as the network and environment changes, and may result in inaccurate beam predictions.

### SUMMARY

The described techniques relate to improved methods, systems, devices, and apparatuses that support techniques for beam management using model adaptation.

Generally, aspects of the present disclosure are directed to techniques used to efficiently train machine learning models used to perform beam predations. In particular, aspects of the present disclosure are directed to signaling and configurations which enable a user equipment (UE) to determine when to report beam measurements that will be used for offline model training, and to determine when outputs of a machine learning model may be used for online model training. For example, a network may configure a UE with a machine learning model that is to be used for beam prediction at the UE. The network may configure the UE with a first set of thresholds used for determining which beam measurements are to be reported to the network for offline training, and/or a second set of thresholds used for determining which beam measurements and model output may be used by the UE for online model training. In this example, the UE may input measurements performed by the UE into the machine learning model to predict beam quality metrics, and will report the measurements to the network for offline training or perform online training using the measurements based on whether or not the predicted beam quality metrics satisfy the respective threshold(s).

A method is described. The method may include receiving, from a network entity, control signaling indicating a machine learning model to be used for beam prediction at the UE, the control signaling further indicating one or more thresholds for reporting outputs from the machine learning model, performing a first set of measurements on a set of reference signals received from the network entity, predicting a first set of beam quality metrics associated with a set of receive (Rx) beams at the UE based on inputting the first set of measurements into the machine learning model, and transmitting, to the network entity, a control message indicating the first set of measurements based on the first set of beam quality metrics satisfying the one or more thresholds.

An apparatus is described. The apparatus may include a processor, memory coupled with the processor, and instructions stored in the memory. The instructions may be executable by the processor to cause the apparatus to receive, from a network entity, control signaling indicating a machine learning model to be used for beam prediction at the UE, the control signaling further indicating one or more thresholds for reporting outputs from the machine learning model, perform a first set of measurements on a set of reference signals received from the network entity, predict a first set of beam quality metrics associated with a set of Rx beams at the UE based on inputting the first set of measurements into the machine learning model, and transmit, to the network entity, a control message indicating the first set of measurements based on the first set of beam quality metrics satisfying the one or more thresholds.

Another apparatus is described. The apparatus may include means for receiving, from a network entity, control signaling indicating a machine learning model to be used for beam prediction at the UE, the control signaling further indicating one or more thresholds for reporting outputs from the machine learning model, means for performing a first set of measurements on a set of reference signals received from the network entity, means for predicting a first set of beam quality metrics associated with a set of Rx beams at the UE based on inputting the first set of measurements into the machine learning model, and means for transmitting, to the network entity, a control message indicating the first set of measurements based on the first set of beam quality metrics satisfying the one or more thresholds.

A non-transitory computer-readable medium storing code is described. The code may include instructions executable by a processor to receive, from a network entity, control signaling indicating a machine learning model to be used for beam prediction at the UE, the control signaling further indicating one or more thresholds for reporting outputs from the machine learning model, perform a first set of measurements on a set of reference signals received from the network entity, predict a first set of beam quality metrics associated with a set of Rx beams at the UE based on inputting the first set of measurements into the machine learning model, and transmit, to the network entity, a control message indicating the first set of measurements based on the first set of beam quality metrics satisfying the one or more thresholds.

Some examples of the method, apparatuses, and non-transitory computer-readable medium described herein may further include operations, features, means, or instructions for receiving, from the network entity, additional control signaling indicating an updated version of the machine learning model, where the additional control signaling may be received based on transmitting the control message.

In some examples of the method, apparatuses, and non-transitory computer-readable medium described herein, the first set of beam quality metrics include a set of probability metrics indicating a relative probability that corresponding beams of the set of Rx beams satisfy a threshold beam performance and the first set of beam quality metrics satisfy the one or more thresholds based on each of the first set of beam quality metrics being less than the one or more thresholds.

Some examples of the method, apparatuses, and non-transitory computer-readable medium described herein may further include operations, features, means, or instructions for performing a second set of measurements on a second set of reference signals received from the network entity and predicting a second set of beam quality metrics associated with the set of Rx beams based on the second set of measurements, where the first set of beam quality metrics satisfy the one or more thresholds based on one or more differences between the first set of beam quality metrics and the second set of beam quality metrics being greater than or equal to the one or more thresholds.

In some examples of the method, apparatuses, and non-transitory computer-readable medium described herein, the first set of beam quality metrics and the second set of beam quality metrics include predicted reference signal received power (RSRP) measurements associated with the set of Rx beams and the one or more thresholds include a threshold RSRP metric.

In some examples of the method, apparatuses, and non-transitory computer-readable medium described herein, the second set of beam quality metrics include RSRP metrics that may be predicted using one or more mathematical operations different from the machine learning model.

In some examples of the method, apparatuses, and non-transitory computer-readable medium described herein, the one or more differences between the first set of beam quality metrics and the second set of beam quality metrics include minimum mean square error (MMSE) metrics.

Some examples of the method, apparatuses, and non-transitory computer-readable medium described herein may further include operations, features, means, or instructions for performing a second set of measurements on a second set of reference signals received from the network entity, predicting a second set of beam quality metrics associated with the set of Rx beams based on inputting the second set of measurements into the machine learning model, and training the machine learning model based using the second set of measurements based on at least one beam quality metric of the second set of beam quality metrics satisfying the one or more additional thresholds.

Some examples of the method, apparatuses, and non-transitory computer-readable medium described herein may further include operations, features, means, or instructions for generating a pseudo label associated with the at least one beam quality metric of the second set of beam quality metrics that satisfies the one or more additional thresholds and inputting, into the machine learning model, the pseudo label, the at least one beam quality metric of the second set of beam quality metrics, and at least one measurement of the second set of measurements which corresponds to the at least one beam quality metric, where the training may be based on the inputting.

In some examples of the method, apparatuses, and non-transitory computer-readable medium described herein, the second set of beam quality metrics include a set of probability metrics indicating a relative probability that corresponding beams of the set of Rx beams satisfy a threshold beam performance and the at least one beam quality metric of the second set of beam quality metrics satisfies the one or more additional thresholds based on the at least one beam quality metric greater than or equal to the one or more additional thresholds.

Some examples of the method, apparatuses, and non-transitory computer-readable medium described herein may further include operations, features, means, or instructions for predicting a first set of beam indices corresponding to the first set of beam quality metrics, the first set of beam indices indicating predicted Rx beams associated with a set of multiple time instances and selectively modifying a beam index of the first set of beam indices based on one or more differences between the beam index and one or more additional beam indices corresponding to one or more time instances of the set of multiple time instances within a consistence window.

Some examples of the method, apparatuses, and non-transitory computer-readable medium described herein may further include operations, features, means, or instructions for receiving an indication of the consistence window via the control signaling, where selectively modifying the beam index may be based on receiving the control signaling.

In some examples of the method, apparatuses, and non-transitory computer-readable medium described herein, selectively modifying at least one predicted beam quality metric of the set of multiple predicted beam quality metrics within the second time interval based on the at least one predicted beam quality metric satisfying an outlier threshold.

Some examples of the method, apparatuses, and non-transitory computer-readable medium described herein may further include operations, features, means, or instructions for selecting an Rx beam from the set of Rx beams based on the first set of beam quality metrics and receiving one or more messages from the network entity using the Rx beam based on the selecting.

Some examples of the method, apparatuses, and non-transitory computer-readable medium described herein may further include operations, features, means, or instructions for transmitting, to the network entity, capability signaling indicating one or more capabilities associated with the UE, where receiving the control signaling may be based on the capability signaling.

Some examples of the method, apparatuses, and non-transitory computer-readable medium described herein may further include operations, features, means, or instructions for performing a second set of measurements on a second set of reference signals received from the network entity, determining a second set of beam quality metrics associated with the set of Rx beams, an additional set of Rx beams, or both, based on inputting the second set of measurements into the machine learning model, and refraining from reporting the second set of measurements to the network entity based on at least one beam quality metric of the second set of beam quality metrics failing to satisfy the one or more thresholds.

A method is described. The method may include transmitting, to a UE, control signaling indicating a machine learning model to be used for beam prediction at the UE, the control signaling further indicating one or more thresholds for reporting outputs from the machine learning model, transmitting a set of reference signals to the UE based on the control signaling, and receiving, from the UE, a control message indicating a first set of measurements associated with the set of reference signals, where the control message is received based on a first set of beam quality metrics associated with the first set of measurements satisfying the one or more thresholds, where the first set of beam quality metrics include outputs of the machine learning model.

An apparatus is described. The apparatus may include a processor, memory coupled with the processor, and instructions stored in the memory. The instructions may be executable by the processor to cause the apparatus to transmit, to a UE, control signaling indicating a machine learning model to be used for beam prediction at the UE, the control signaling further indicating one or more thresholds for reporting outputs from the machine learning model, transmit a set of reference signals to the UE based on the control signaling, and receive, from the UE, a control message indicating a first set of measurements associated with the set of reference signals, where the control message is received based on a first set of beam quality metrics associated with the first set of measurements satisfying the one or more thresholds, where the first set of beam quality metrics include outputs of the machine learning model.

Another apparatus is described. The apparatus may include means for transmitting, to a UE, control signaling indicating a machine learning model to be used for beam prediction at the UE, the control signaling further indicating one or more thresholds for reporting outputs from the machine learning model, means for transmitting a set of reference signals to the UE based on the control signaling, and means for receiving, from the UE, a control message indicating a first set of measurements associated with the set of reference signals, where the control message is received based on a first set of beam quality metrics associated with the first set of measurements satisfying the one or more thresholds, where the first set of beam quality metrics include outputs of the machine learning model.

A non-transitory computer-readable medium storing code is described. The code may include instructions executable by a processor to transmit, to a UE, control signaling indicating a machine learning model to be used for beam prediction at the UE, the control signaling further indicating one or more thresholds for reporting outputs from the machine learning model, transmit a set of reference signals to the UE based on the control signaling, and receive, from the UE, a control message indicating a first set of measurements associated with the set of reference signals, where the control message is received based on a first set of beam quality metrics associated with the first set of measurements satisfying the one or more thresholds, where the first set of beam quality metrics include outputs of the machine learning model.

Some examples of the method, apparatuses, and non-transitory computer-readable medium described herein may further include operations, features, means, or instructions for training the machine learning model based on the first set of measurements, the first set of beam quality metrics, or both and transmitting, to the UE, additional control signaling indicating an updated version of the machine learning model based on training the machine learning model.

In some examples of the method, apparatuses, and non-transitory computer-readable medium described herein, the first set of beam quality metrics include a set of probability metrics indicating a relative probability that corresponding beams of the set of Rx beams satisfy a threshold beam performance and the first set of beam quality metrics satisfy the one or more thresholds based on each of the first set of beam quality metrics being less than the one or more thresholds.

In some examples of the method, apparatuses, and non-transitory computer-readable medium described herein, the first set of beam quality metrics satisfy the one or more thresholds based on one or more differences between the first set of beam quality metrics and a second set of beam quality metrics being greater than or equal to the one or more thresholds.

In some examples of the method, apparatuses, and non-transitory computer-readable medium described herein, the first set of beam quality metrics and the second set of beam quality metrics include predicted RSRP measurements associated with the set of Rx beams and the one or more thresholds include a threshold RSRP metric.

In some examples of the method, apparatuses, and non-transitory computer-readable medium described herein, the second set of beam quality metrics include RSRP metrics that may be predicted using one or more mathematical operations different from the machine learning model.

In some examples of the method, apparatuses, and non-transitory computer-readable medium described herein, the one or more differences between the first set of beam quality metrics and the second set of beam quality metrics include MMSE metrics.

In some examples of the method, apparatuses, and non-transitory computer-readable medium described herein, the control signaling further indicates one or more additional thresholds for training the machine learning model at the UE.

Some examples of the method, apparatuses, and non-transitory computer-readable medium described herein may further include operations, features, means, or instructions for receiving, from the UE, capability signaling indicating one or more capabilities associated with the UE, where transmitting the control signaling may be based on the capability signaling.

### BRIEF DESCRIPTION OF THE DRAWINGS

FIG. 1 illustrates an example of a wireless communications system that supports techniques for beam management using model adaptation in accordance with one or more aspects of the present disclosure.

FIG. 2 illustrates an example of a wireless communications system that supports techniques for beam management using model adaptation in accordance with one or more aspects of the present disclosure.

FIG. 3 illustrates an example of a machine learning model configuration that supports techniques for beam management using model adaptation in accordance with one or more aspects of the present disclosure.

FIG. 4 illustrates an example of a process flow that supports techniques for beam management using model adaptation in accordance with one or more aspects of the present disclosure.

FIG. 5 illustrates an example of a process flow that supports techniques for beam management using model adaptation in accordance with one or more aspects of the present disclosure.

FIGS. 6 and 7 illustrate block diagrams of devices that support techniques for beam management using model adaptation in accordance with one or more aspects of the present disclosure.

FIG. 8 illustrates a block diagram of a communications manager that supports techniques for beam management using model adaptation in accordance with one or more aspects of the present disclosure.

FIG. 9 illustrates a diagram of a system including a device that supports techniques for beam management using model adaptation in accordance with one or more aspects of the present disclosure.

FIGS. 10 through 13 illustrate flowcharts showing methods that support techniques for beam management using model adaptation in accordance with one or more aspects of the present disclosure.

### DETAILED DESCRIPTION

Some wireless devices (e.g., user equipment (UEs)) may be configured to perform measurements on reference signals from the network and input the measurements into a machine learning algorithm to predict relative qualities of receive (Rx) beams that should be used for future communications. Machine learning models may not be able to adapt as the network and environment changes, and may result in inaccurate beam predictions. In such cases, the model may require further training, which includes offline training and online training. However, both training methods suffer from respective shortfalls.

For example, with offline training, the UE may report measurements to the network so that the network may further train the model “offline” (e.g., while the model is not being used), where the network subsequently re-configures the UE with the newly trained model. In such cases, offline training may require extensive signaling overhead to report measurements to the network, and the offline training may result in increased beam prediction latency. Comparatively, with online training, the UE may select Rx beam predictions from the machine learning model and use the Rx beam predictions as inputs to further train the model “online” (e.g., as the UE continues to use the model). However, online training techniques may not be effective in cases where the model is not accurately performing beam predictions, such as in cases with quickly changing network and environmental conditions.

Accordingly, aspects of the present disclosure are directed to techniques that enable wireless devices to efficiently train machine learning models used to perform beam predations. In particular, aspects of the present disclosure are directed to signaling and configurations which enable a UE to determine when to report beam measurements that will be used for offline model training, and to determine when outputs of a machine learning model may be used for online model training. For example, a network may configure a UE with a machine learning model that is to be used for beam prediction at the UE. The network may configure the UE with a first set of thresholds used for determining which beam measurements are to be reported to the network for offline training, and/or a second set of thresholds used for determining which beam measurements and model output may be used by the UE for online model training. In this example, the UE may input measurements performed by the UE into the machine learning model to predict beam quality metrics, and will report the measurements to the network for offline training or perform online training using the measurements based on whether or not the predicted beam quality metrics satisfy the respective threshold(s).

In some cases, beam measurements/model outputs which exhibit relatively low confidence values or accuracy may satisfy the first set of thresholds, and may therefore be reported to the network. For instance, model outputs/predictions that have a small confidence value (e.g., relatively low probability of being accurate) may satisfy the first set of thresholds, and may therefore be reported to the network for offline training. Moreover, beam predictions that significantly deviate from predictions performed using non-machine learning techniques may also satisfy the first set of thresholds, and may therefore be reported to the network for offline training. Comparatively, beam predictions that exhibit high confidence levels (e.g., relatively high probability of being accurate) may satisfy the second set of thresholds, and may therefore be used for online model training at the UE.

Aspects of the disclosure are initially described in the context of wireless communications systems. Additional aspects of the disclosure are described in the context of an example machine learning model configuration and example process flows. Aspects of the disclosure are further illustrated by and described with reference to apparatus diagrams, system diagrams, and flowcharts that relate to techniques for beam management using model adaptation.

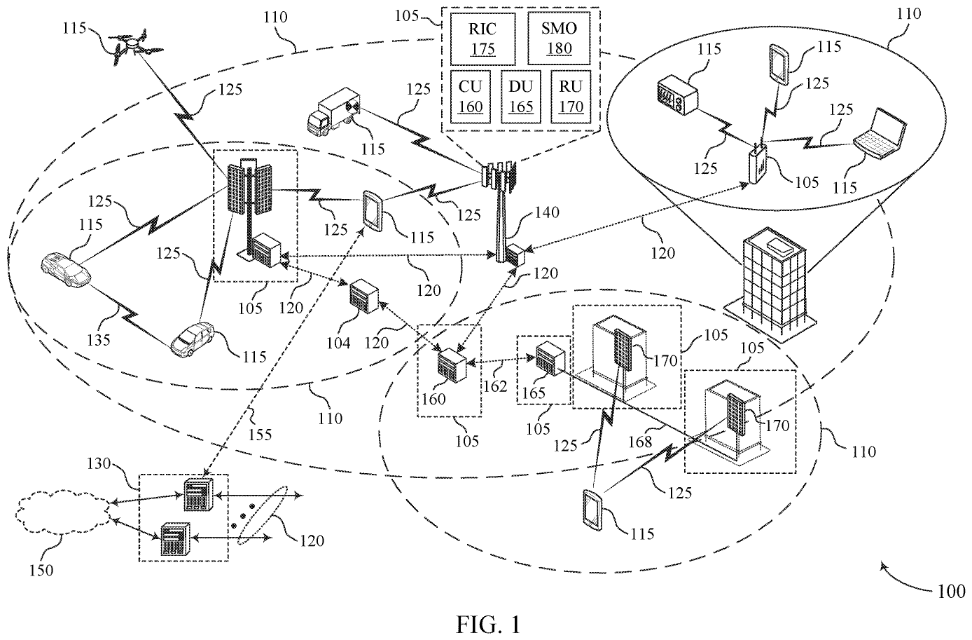

FIG. 1 illustrates an example of a wireless communications system 100 that supports techniques for beam management using model adaptation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for beam management using model adaptation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Nf may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a Tx beam, an Rx beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, the respective devices of the wireless communications system 100 may support techniques that enable wireless devices (e.g., UEs 115) to efficiently train machine learning models used to perform beam predations. In particular, the wireless communications system 100 may support signaling and configurations which enable a UE 115 to determine when to report beam measurements that will be used for offline model training, and to determine when outputs of a machine learning model may be used for online model training.

For example, a network entity 105 of the wireless communications system 100 may configure a UE 115 with a machine learning model that is to be used for beam prediction at the UE 115. The network entity 105 may configure the UE 115 with a first set of thresholds used for determining which beam measurements are to be reported to the network for offline training, and/or a second set of thresholds used for determining which beam measurements and model output may be used by the UE 115 for online model training. The UE 115 may input measurements performed by the UE 115 into the machine learning model to predict beam quality metrics associated with Rx beams at the UE 115. In this example, the UE 115 may be configured to report the measurements to the network entity 105 for offline training or perform online training using the measurements based on whether or not the predicted beam quality metrics satisfy the respective threshold(s).

Techniques described herein may enable efficient training of machine learning models used for beam prediction, while simultaneously reducing control signaling overhead used to perform model training. In particular, by configuring UEs 115 with thresholds used for reporting inputs/outputs of a machine model to the network for offline training, techniques described herein may enable UEs 115 to report model inputs/outputs only in cases where offline training may be expected or required. As such, techniques described herein may reduce control signaling overhead associated with offline training, reduce a frequency of offline training, and reduce a latency of beam prediction performed using machine learning models. Moreover, by configuring UEs 115 with thresholds used for reporting inputs/outputs of a machine model to the network for offline training, techniques described herein may enable UEs 115 to perform online training using model outputs with high confidence values that are expected to improve the efficiency and reliability of the machine learning model to perform future beam predictions.

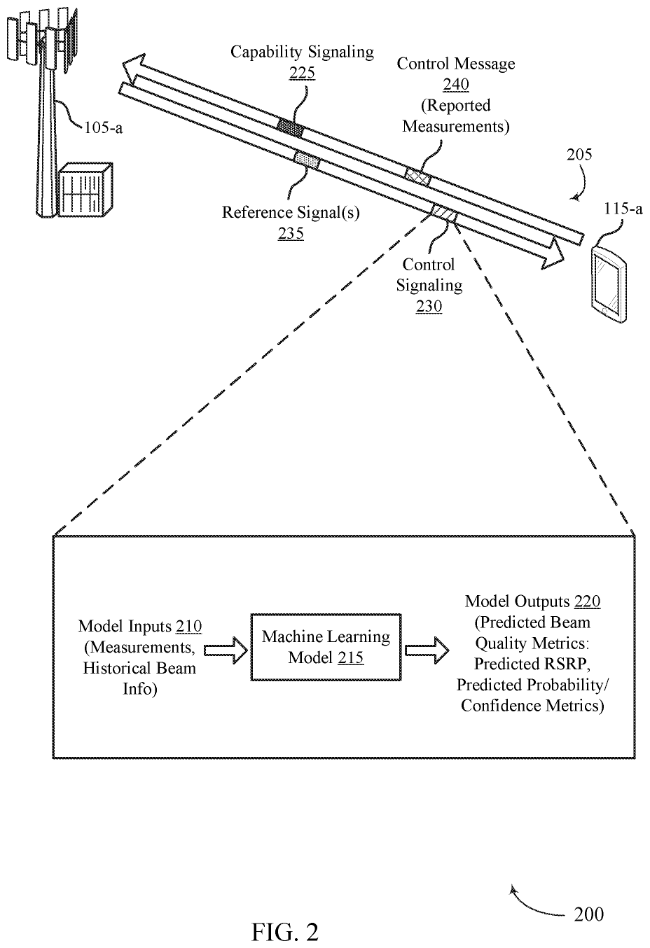

FIG. 2 illustrates an example of a wireless communications system 200 that supports techniques for beam management using model adaptation in accordance with one or more aspects of the present disclosure. In some examples, aspects of the wireless communications system 200 may implement, or be implemented by, aspects of the wireless communications system 100. In particular, the wireless communications system 200 may support techniques for training machine learning models used for beam prediction, as described previously herein.

The wireless communications system 200 may include a UE 115-a and a network entity 105-a, which may be examples of wireless devices as described herein. In some aspects, the UE 115-a and the network entity 105-a may communicate with one another using a communication link 205, which may be an example of an NR or LTE link, a sidelink (e.g., PC5 link), and the like, between the respective devices. In some cases, the communication link 205 may include an example of an access link (e.g., Uu link) which may include a bi-directional link that enables both uplink and downlink communication. For example, the UE 115-a may transmit uplink signals, such as uplink control signals or uplink data signals, to one or more components of the network entity 105-a using the communication link 205, and one or more components of the network entity 105-a may transmit downlink signals, such as downlink control signals or downlink data signals, to the UE 115-a using the communication link 205.

As noted previously herein, some wireless devices (e.g., UEs 115) may be configured to receive reference signals from the network using different Rx beams, and perform measurements on the received reference signals in order to identify relative qualities of the respective Rx beams. In such cases, the UEs 115 may transmit measurement reports (e.g., CSI reports) to the network indicating the measurements so that the network can schedule communications at the UE 115 using Rx beams that are best for the UE 115 (e.g., Rx beams that exhibit a threshold quality).

Wireless communications systems may be configured to implement various types of machine learning models to perform beam predictions, including neural network functions (NNFs), neural network models, and the like. In the context of NNFs, each NNF may be associated with a function Y=F(X), where a standardized input X is input into the respective NNF to generate standardized output Y. Each NNF within a wireless communications system may be identified by a standardized NNF identifier (ID), where some wireless communications may also support non-standardized NNF IDs associated with NNFs used for private extensions. NNFs may be associated with mandatory information elements for inter-vendor interworking, and/or optional information elements for flexible implementation. In some cases, a single NNF may be supported by multiple models (e.g., vendor specific implementation).

Neural network models may be defined as a model structure and a parameter set, where the neural network models may be defined by the operator, vendors, third parties, or any combination thereof. The model structure of a neural network model may be identified by a model ID, which may include a default parameter set. Each model ID may be unique within the wireless communications system, where each model ID may be associated with one or more corresponding NNFs. The parameter sets for the neural network models may include weights of the neural network model (e.g., weights for the respective inputs for the models) and other configuration parameters. The parameter sets may be location and/or configuration specific.

In some cases, UEs 115 may utilize past measurements to predict beam measurements (e.g., future Rx beam qualities) at some point in the future for the same or different beam sets, and may report the predicted/extrapolated beam measurements to the network. In other words, wireless devices of a wireless communications system may be configured to train an algorithm (e.g., machine learning model) to predict future RSRP measurements for of beam set #2 based on past RSRP measurement of beam set #1, where beam set #1 and beam set #2 may include the same beams, overlapping beams, or completely different sets of beams. In some cases, the algorithm/machine learning model may include a recursive neural network or traditional algorithm.

In some cases, the wireless device (e.g., network entity 105-a, UE 115-a) which implements the machine learning model may be configured to measure reference signals such as SSBs (e.g., a subset of SSBs), and input the measurements into the machine learning model to predict measurements (e.g., SSB measurements) in the future. For example, the UE 115-a may be configured to perform measurements for received SSBs, an input the measurements into a machine learning model/algorithm in order to predict some refined CSI-RS beams for unicast PDSCH/PDCCH. Additionally, or alternatively, the output of the machine learning model may include beam IDs that are expected to exhibit some threshold performance (e.g., beam IDs for the beams predicted to exhibit the highest performance) at some point in the future.

The use of machine learning models for performing beam prediction may reduce reference signal overhead within the network, as the prediction of future beams and/or beam metrics may reduce frequency with which the respective devices transmit/receive reference signals for beam/channel tracking. Moreover, using machine learning models to perform beam prediction may reduce uplink feedback, as it may reduce the frequency with which the UE 115-a transmits channel estimation feedback. As such, by reducing the frequency of channel estimation feedback, machine learning models used for beam prediction may also reduce power consumption at the UE 115-a.

Machine learning models/algorithms used for beam prediction may be trained and maintained by network (e.g., network entity 105-a), where the machine learning models are run/executed by the network, or distributed to and run/executed by UEs 115 within the network. In cases where machine learning models are run/executed by UEs 115, the network may train and configure the models and distribute the trained models to the respective UEs 115.

For example, in accordance with a first implementation, machine learning modules/models used for beam prediction may be trained and run by the network entity 105-a. In such cases, the UE 115-a may transmit reference signals (e.g., SRSs) to the network entity 105-a, where the network entity 105-a performs measurements on the received reference signals and inputs the measurements into the machine learning model for performing beam prediction (e.g., predicting future RSRPs, future beam IDs, etc.). The network entity 105-a may then transmit prediction results (e.g., predicted RSRPs, predicted beam IDs) to the UE 115-a, and may schedule communications between the network entity 105-a and the UE 115-a based on the predictions. The UE 115-a may perform measurements and/or generate reports (e.g., CSI report, beam report) that are provided to the network entity 105-a so that the network entity 105-a may utilize the measurements/generated reports to further train/update the machine learning model (e.g., by comparing predicted RSRPs to actual RSRP measurements performed by the UE 115-a). This first implementation in which the machine learning model is trained and run by the network entity 105-a may be useful in cases where the UE 115-a exhibits relatively low power and/or processing capabilities.

Comparatively, in accordance with a second implementation, machine learning modules/models used for beam prediction may be initially trained by the network entity 105-a, but run/executed by the UE 115-a. For example, the network entity 105-a may configure UE 115-a with a machine learning model, where the UE 115-a is configured to run the configured machine learning model using measurements performed on reference signals received from the network entity 105-a. In this example, the UE 115-a may report predicted outputs of the machine learning model (e.g., predicted RSRPs, predicted beam IDs) to the network entity 105-a, such as based on certain triggering events/conditions for reporting model outputs. The second implementation in which machine learning models are run/executed by the UE 115-a may take advantage of the fact that the network entity 105-a generally transmits reference signals more frequency compared to the UE 115-a. Moreover, the second implementation may result in less signaling overhead as compared to the first implementation, but may require higher computational capabilities and power consumption at the UE 115-a.

The use of machine learning-based beam prediction has been shown to result in significant performance gain compared to traditional algorithms used for beam determination/prediction. However, such machine learning solutions used for beam prediction may be dependent on the data distribution of inputs provided to the machine learning models. For example, as the environment changes (e.g., as UE 115-a moves within the network, or as channel conditions between the UE 115-a and the network entity 105-a change), the configured machine learning model may not adapt to the variation, and may therefore fail to make accurate predictions for beam management. In such cases, the pre-configured machine learning models may be unable to make accurate predictions due to the changing inputs resulting from the changing environment (e.g., the model may make inaccurate or unreliable predictions due to the changing environment/inputs).

In cases where a machine learning model is unable to perform accurate predictions, the model may require further training, which may include offline training and/or online training. However, both training methods suffer from respective shortfalls.

In the context of offline training, the wireless device training the model may collect new data (e.g., perform new measurements), manually label the data, and further train/finetune the model using the new, labeled data. For example, the UE 115-a may report measurements to the network, where the network further finetunes the model and re-configures the UE 115-a with an updated model that will be used for subsequent beam prediction. However, offline training may increase beam prediction latency, as the UE 115-a may be unable to use the outdated model while the model is being trained offline by the network. Moreover, by the time the UE 115-a is re-configured with the updated model, the updated/finetuned model may already be out of date and unable to perform accurate predictions.

Comparatively, online model training/adaptation may be based on pseudo-labeling, where the UE 115-a may select convinced data and set the prediction as the pseudo labeling. In other words, the UE 115-a may perform online model training by taking outputs/predictions from a machine learning model, labeling the outputs/predictions as being accurate or precise, and inputting the labeled outputs/predictions back into the model to further train the model. Online model training may enable the model to more efficiently adapt to environmental variation, and reduce a latency of model training. However, online training techniques may not be effective in cases where the model is not accurately performing beam predictions, such as in cases with quickly changing network and environmental conditions. In other words, not all outputs from the model may be effective for model finetuning.

Such shortfalls of offline and online model training may reduce the efficacy of machine learning-based beam prediction techniques, and therefore prevent widespread use of machine learning models for beam prediction.

Accordingly, aspects of the present disclosure are directed to techniques that enable wireless devices to efficiently train machine learning models used to perform beam predations. In particular, aspects of the present disclosure are directed to signaling and configurations which enable the UE 115 to determine when to report beam measurements that will be used for offline model training, and to determine when outputs of a machine learning model may be used for online model training. In this regard, aspects of the present disclosure may enable online model adaptation with lower latency, and may enable the UE 115-a to select outputs from the model that may be used to effectively train and finetune the model with limited bandwidth cost.

For example, referring to the wireless communications system 200 illustrated in FIG. 2, the UE 115-a may transmit capability signaling 225 to the network entity 105-a. The capability signaling 225 may indicate one or more capabilities associated with the ability of the UE 115-a to perform future beam predictions, such as supported machine learning models 215, processing capabilities, memory capabilities, and the like. For example, the capability signaling 225 may indicate one or more machine learning models 215 usable for performing beam predictions that are supported by the UE 115-a.

The UE 115-a may receive, from the network entity 105-a, control signaling 230 indicating a machine learning model 215 to be used for beam prediction at the UE 115-a. For example, the control signaling 230 may indicate a machine learning model 215 that is supported by the UE 115-a, as indicated via the capability signaling 225. In this regard, the network entity 105-a may indicate what model inputs 210 are to be used for the machine learning model 215, and what model outputs 220 for beam prediction are to be predicted by the UE 115-a using the machine learning model 215.

In some aspects, the control signaling 230 may additionally indicate one or more thresholds for reporting outputs from the machine learning model 215. For example, as will be described in further described herein, the control signaling 230 may indicate thresholds β and/or δ that are used by the UE 115-a for determining if/when the UE 115-a is expected to report outputs from the machine learning model 215 to the network for offline training. Additionally, or alternatively, the control signaling 230 may indicate a threshold τ that is used by the UE 115-a for determining if/when the UE 115-a may utilize inputs/outputs of the machine learning model 215 for online model training at the UE 115-a.

In some aspects, the network entity 105-a may transmit a set of reference signals 235 (e.g., synchronization signal blocks (SSBs)) to the UE 115-a. The network entity 105-a may transmit reference signals 235 that will be used by the UE 115-a for estimating channel conditions and performing beam predictions.

In some aspects, the UE 115-a may receive the reference signals 235 using one or more Rx beams at the UE 115-a. For example, the UE 115-a may scan through a set of Rx beams (e.g., Rx beam 1, Rx beam 2, Rx beam 3, etc.) to receive the respective reference signals 235 in order to evaluate a relative performance or efficiency of the respective Rx beams for receiving communications from the network entity 105-a.

In some aspects, the UE 115-a may perform a set of measurements on the set of reference signals 235. For example, in cases where the UE 115-a receives the reference signals 235 with a set of Rx beams including a first Rx beam, a second Rx beam, and a third Rx beam, the UE 115-a may perform measurements for each of the first, second, and third Rx beams. Additionally, or alternatively, the UE 115-a may perform measurements using the same Rx beam(s) at different points in time. For example, the network entity 105-a may transmit reference signals 235 within a first time interval (T₁), a second time interval (T₂), a third time interval (T₃). In this example, the UE 115-a may receive the reference signals 235 using the same Rx beam (or set of Rx beams) for each of the respective time intervals, and may therefore perform measurements to evaluate the relative performance of the Rx beam(s) over time.

The first set of measurements may include, but are not limited to, RSRP, RSRQ, SNR, SINR, CQI, RSSI, or any combination thereof. In some cases, the measurements performed by the UE 115-a may be based on what model input(s) 210 are to be used by the machine learning model 215 for beam prediction.

The UE 115-a may predict a first set of beam quality metrics associated with Rx beam(s) at the UE 115-a based on inputting the first set of measurements into the machine learning model 215. In this regard, the measurements may include the model inputs 210, and the beam quality metrics may include the model outputs 220. The first set of beam quality metrics (e.g., model outputs 220) may include predicted metrics associated with the Rx beam(s) for one or more time intervals in the future. In some cases, the Rx beam(s) associated with the outputs/predictions of the machine learning model 215 may be the same or different compared to the Rx beam(s) used to receive the reference signals 235.

The model outputs 220 (e.g., predicted beam quality metrics) may include any outputs known in the art, including predicted measurements associated with Rx beams (e.g., predicted RSRP, RSRQ, SNR, SINR, CQI, RSSI), predicted probability or confidence values (e.g., probability metrics that corresponding Rx beams will exhibit some threshold level of performance or quality at some time in the future), or both.

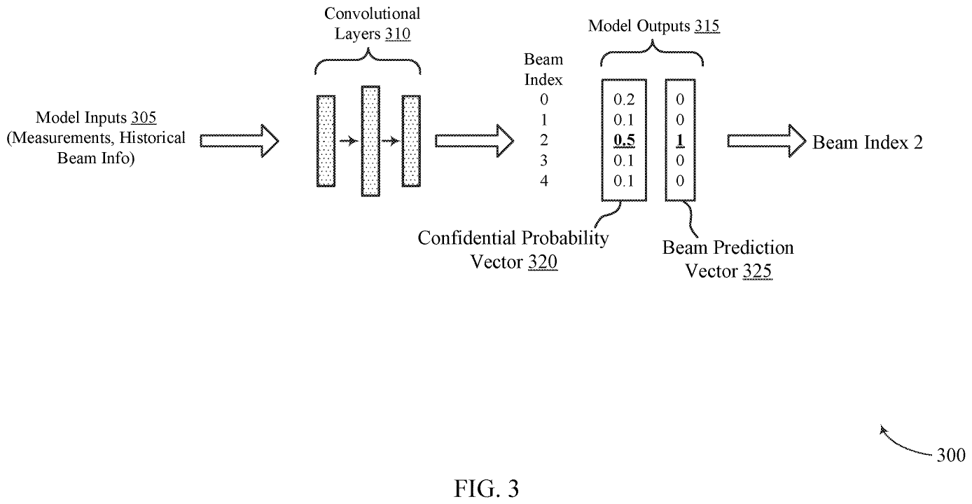

For example, in accordance with a first implementation, the model outputs 220 may include predicted beam indices and corresponding confidential probability values (e.g., probability metrics). This implementation may be further shown and described with reference to FIG. 3.

FIG. 3 illustrates an example of a machine learning model configuration 300 that supports techniques for beam management using model adaptation in accordance with one or more aspects of the present disclosure. In some examples, aspects of the machine learning model configuration 300 may implement, or be implemented by, aspects of the wireless communications system 100, the wireless communications system 200, or both.

In particular, the machine learning model configuration 300 may illustrate an example of the machine learning model 215 shown and described in FIG. 2. For example, the machine learning model configuration 300 illustrates model inputs 305 and model outputs 315, which may include examples of the model inputs 210 and the model outputs 220 illustrated in FIG. 2. The machine learning model configuration 300 further illustrates a set of convolutional layers 310 of a machine learning model, such as the machine learning model 215 illustrated in FIG. 2.

In some implementations, a UE 115 may input model inputs 305 into the convolutional layers 310 of the machine learning model, where the machine learning model is configured to generate model outputs 315 associated with predicted beam quality metrics. As shown in FIG. 3, the model outputs 315 may include a confidential probability vector 320 and a beam prediction vector 325.

The confidential probability vector 320 may include probability metrics indicating relative probabilities that corresponding Rx beams (denoted by beam indices) will exhibit some threshold level of performance or quality for some future time interval. In some cases, the sum of the probability metrics of the confidential probability vector may add up to 1. The beam prediction vector 325 may be based on the confidential probability vector 320 and may indicate a prediction as to which Rx beam should be used for communications within some future time interval. As such, the beam prediction vector 325 may include a single “1” value indicating the Rx beam that is predicted to have the highest quality/performance, where the remaining values in the beam prediction vector 325 for the remaining Rx beams are set to “0.”

For instance, based on the model inputs 305 provided to the model, the model shown in FIG. 3 may predict that Rx beam index 2 is associated with the highest probability metric. In other words, the machine learning model may predict that Rx beam index 2 has the highest probability of exhibiting some threshold level of quality/performance out of the Rx beam indices 0-4. As such, in this example shown in FIG. 3, the machine learning model may therefore predict that Rx beam index 2 should be used for receiving downlink signals during some future time interval.

In some aspects, the UE 115 may be configured to compare the probability metrics of the confidential probability vector 320 to a threshold β to determine whether or not the UE 115 should report the measurements/model inputs 305 and/or model outputs 315 to the network for offline training. In some cases, the UE 115 may be expected to report the model inputs 305 (e.g., measurements) and/or corresponding model outputs 315 (e.g., confidential probability vector 320, beam prediction vector 325) to the network only when the confidential probability is less than or equal to the threshold β. In some aspects, the threshold β may be configured or indicated by the network, pre-defined by the network and/or at the UE 115, or both.

In some cases, the confidential probability may include the highest probability metric of the confidential probability vector 320, the median or mean probability metric of the confidential probability vector 320, and the like. Moreover, the network may configure the machine learning model to output the confidential probability to identify the valuable or not. Such a machine learning model may be used to perform beam prediction, output confidential probability values, or both.

For example, the network may configure the threshold β for reporting model outputs 315 to the network as β=0.6. As such, any prediction with the confidential probability lower than β should be recorded for the offline optimization. In this example shown in FIG. 3, the UE 115 may input measurements that result in a highest probability metric (e.g., confidential probability) of 0.5. In this example, the UE 115 may determine that the confidential probability (e.g., highest probability metric) is less than the threshold (e.g., 0.5<β), and may therefore report the model inputs 305 and/or model outputs 315 to the network (e.g., via a control message 240 illustrated in FIG. 2) so that the network may utilize the model inputs 305 and/or model outputs 315 for offline training.

By way of another example, the network may again configure the threshold β for reporting model outputs 315 to the network as β=0.6. As such, any prediction with the confidential probability lower than β should be recorded for the offline optimization. In this example, the UE 115 may input measurements that result in a highest probability metric (e.g., confidential probability) of 0.8. In this example, the UE 115 may determine that the confidential probability (e.g., highest probability metric) is greater than the threshold (e.g., 0.8>β), and may therefore refrain from reporting the model inputs 305 and/or the model outputs 315 to the network. In other words, because the model predicted at least one Rx beam with a relatively high confidence value/probability metric, the UE 115 may determine that no offline training expected.

Reference will again be made to FIG. 2. In additional or alternative implementations, the model outputs 220 predicted by the machine learning model 215 may include predicted measurements (e.g., predicted RSRP, RSRQ, SNR, SINR, CQI, RSSI) associated with Rx beams at some time interval(s) in the future.

In some implementations, in order to monitor the status/accuracy of the machine learning model 215, the UE 115-a may be configured to compare model outputs 220 (e.g., predicted RSRP measurements) to predictions performed by non-machine learning-based techniques or algorithms. In such cases, the UE 115-a may be configured to report the model inputs 210 and/or model outputs 220 to the network for offline training only when the difference between the machine-learning based model outputs 220 and estimations from monitoring reference signals 235 is greater than or equal to a threshold δ. In some aspects, the threshold δ may be configured or indicated by the network, pre-defined by the network and/or at the UE 115, or both.

In such cases, the monitoring reference signals 235 may be configured with a sparse pattern to reduce resource utilization, and the network may indicate for the UE 115-a to make beam predictions using both the machine learning model 215 and traditional algorithms (e.g., mathematical operations other than the machine learning model 215). Moreover, the monitoring reference signals 235 may include a subset of reference signals 235 used for beam management, and/or newly configured reference signals 235.

In other words, in cases where the first set of beam quality metrics include predicted measurements associated with the set of Rx beams, the UE 115-b may compare the predicted measurements (e.g., model outputs 220) to actual measurements predicted using mathematical operations different from the machine learning model (e.g., traditional algorithms), and may compare the difference between the machine learning-predicted measurements (e.g., model outputs 220) to a threshold metric (δ).

For instance, the first set of beam quality metrics (e.g., model outputs 220) may include predicted RSRP measurements associated with the set of Rx beams predicted by the machine learning model 215. In this example, the UE 115-a may perform a second set of measurements using non-machine learning-based techniques (e.g., traditional algorithms). The UE 115-a may then determine differences (e.g., median minimum square error (MMSE) metrics) between the first set of RSRP measurements (RSRP₁) predicted by the machine learning model 215, and the second set of RSRP measurements (RSRP₂) predicted by non-machine learning-based algorithms. For instance, in beam management, one predicted RSRP value for each Rx beam may be generated based on previous RSRP measurements, and one reference signal 235 could be used to estimate the real RSRP based on traditional algorithms.

In this example, the first set of beam quality metrics (e.g., first set of RSRP measurements) predicted by the machine learning model 215 may satisfy a threshold RSRP metric (δ) if one or more differences between the first set of RSRP measurements (RSRP₁) predicted by the model and the second set of RSRP measurements (RSRP₂) predicted using non-machine learning operations is greater than or equal to the threshold RSRP metric (δ) (e.g., threshold RSRP metric δ satisfied if |RSRP₁−RSRP₂|≥δ). For instance, the UE 115-a may determine the MMSE based on MMSE=mean{(RSRP_{predicted}−RSRP_{estimated})²}, and may report the inputs/outputs (e.g., via a control message 240) if MMSE is greater than the threshold δ (where RSRP_{predicted} are RSRP measurements predicted using the machine learning model 215, and where RSRP_{estimated} are RSRP measurements predicted using other non-machine learning-based mathematical operations.

In such cases where the threshold δ is satisfied, this may indicate that the model outputs 220 of the machine learning model 215 deviate significantly from what would be predicted using non-machine learning-based algorithms, and that the inputs and/or outputs should be reported to the network for offline training.

In some aspects, the control signaling 230 may additionally or alternatively indicate thresholds that are used to determine if/when the UE 115-a should use model outputs 220 for online model training at the UE 115-a. As noted previously herein, online model training/adaptation may utilize logged new data (e.g., model outputs 220) to finetune the machine learning model 215 (rather than offline training techniques that are used by the network to re-configure the model). Such online training techniques may be used to adapt the machine learning model 215 to new data distributions (e.g., new model inputs 210 resulting from changing channel conditions) using pseudo-labeling.

As such, in the context of beam management, model outputs 220 with high confidential probabilities (e.g., high probability metrics indicated via the confidential probability vector 320 in FIG. 3) may be used to for pseudo labeling, and may be re-input into the machine learning model 215 to finetune and perform online model training.

For example, reference will again be made to FIG. 3. Based on the model inputs 305 provided to the model, the model shown in FIG. 3 may generate model outputs 315 including a confidential probability vector 320 including probability metrics associated with the respective Rx beams. Moreover, the network may configure or indicate a threshold τ=0.8 for online model training. In this example, the UE 115 may determine that any probability metrics which are greater than the threshold τ=0.8 satisfy the threshold, and may therefore be used for online model training (e.g., re-input back into the model for online training). In other words, based on the confidential probability vector 320, the probability metric with the high probability that satisfies the threshold τ=0.8 may be set as a pseudo label, where the corresponding model inputs 305 and generated pseudo label may be logged and re-input into the machine learning model for online training to finetune the model.

As described herein, the thresholds β and τ may both be associated with probability metrics of the confidential probability vector 320. However, the threshold β used for reporting outputs of the machine learning model and the threshold t used for online model training are different. Specifically, τ is greater than β. For example, the network may set the thresholds as β=0.5 and τ=0.9. In such cases, the UE 115-a may report beam quality metrics (e.g., probability metrics) for offline training if none of the values of the confidential probability vector 320 are greater than β=0.5, and may utilize beam quality metrics (e.g., probability metrics) for online training for respective beam quality metrics which are greater than τ=0.9.

Reference will again be made to FIG. 2. In some cases, model outputs 220 predicted by the machine learning model 215 may be expected to be coherent in the time domain, frequency domain, and/or spatial domain. As such, as it applies to beam management and prediction, machine learning predictions may be expected to be consistent within a given time window. In other words, when predicting which Rx beams should be used for a short time interval, the UE 115-a may expect that the machine learning model 215 will predict that the same Rx beam will exhibit the best performance over the short time interval, rather than predicting five different Rx beams will exhibit the best performance over different subsets of the short time interval.

Stated differently, in some aspects, the wireless devices may expect time domain consistence with model outputs 220 of the machine learning model 215. The term “time domain consistence” means that predictions in one given time window should be consistent. The duration of the consistence window may depend on different factors, such as a moving speed of the UE 115-a. For instance, slower moving speed may result in slower changes in the channel environment, and therefore the model outputs 220 should change slower and less dramatically over time (e.g., longer consistence window in which model outputs 220 are expected to be consistent/coherent). Comparatively, faster moving speed may result in faster changes in the channel environment, and therefore the model outputs 220 should change faster and more dramatically over time (e.g., shorter consistence window in which model outputs 220 are expected to be consistent/coherent).

Accordingly, in some aspects, the network entity 105-a may indicate (e.g., via the control signaling 230) a consistence window, where the UE 115-a is configured to selectively modify predictions of the machine learning model 215 such that model outputs 220 are consistent/coherent within the consistence window. In other words, within the window, beam predictions (and/or other model outputs 220) should be the same with high probability. The length of the consistence window may be defined or indicated by the network, where. Moreover, in some cases, the length of the consistence window may be adapted to network conditions or different deployment scenarios (e.g., shorter length of the consistence window in indoor or high-traffic scenarios with quickly changing network conditions).

For example, the UE 115-a may utilize the machine learning model 215 to make beam predictions for a consistence window including ten different time intervals (e.g., consistence window with time intervals {RSₜ₀, RSₜ₁, . . . , RSₜ₉}). The machine learning model may make ten predictions for Rx beams that should be used in the ten respective time intervals, as represented by beam indices [1,2,1,1,0,1,1,2,1,1]. In this example, since the model outputs 220 (e.g., Rx beam index predictions) are expected to be coherent/consistent within the consistence window, the UE 115-a may selectively adjust the model outputs 220 to be [1,1,1,1,1,1,1,1,1,1]. In this example, the samples/model outputs 220 that were selectively adjusted (e.g., RSₜ₁, RSₜ₄, RSₜ₇) may be used for model training (e.g., use {RSₜ₁, beam index 1}, {RSₜ₄, beam index 1}, {RSₜ₇, beam index 1} for additional model finetuning/training).

In some cases, consistence windows may be defined in the time domain, the frequency domain, and/or the spatial domain. In other words, model outputs 220 may expected to be coherent/consistent with respect to the time domain, frequency domain, and/or spatial domain (e.g., for a given time interval in a given spatial location, the machine learning model 215 should be expected to predict the same Rx beam should be used for some quantity of consecutive frequency bands).

In the context of model outputs 220 including predicted measurements, such as predicted RSRP measurements, the predicted RSRP measurements may be expected to smoothly vary among adjacent model outputs 220 within a consistence window. The system (network or standard) may define the filtering method to process the predictions within the consistence window. Filtering methods used to selectively modify model outputs 220 within a consistence window may include, but are not limited to, averaging operations, infinite impulse response (IIR) filters (e.g., 1-tap IIR filter), and the like.

For example, model outputs 220 may include predicted RSRP values for one Rx beam in different occasions: RSRP(dbm)=[10, 11, 13, 40, 14, 11, 12, . . . ]. In this example, the UE 115-a may filter the RSRP value of “40” based on the assumption that predicted RSRP measurements may be expected to smoothly vary among adjacent model outputs 220 within a consistence window. For instance, the UE 115-a may perform an averaging operation based on adjacent values, (e.g., selectively modify the “40” value to a “12.25” value by the following operation: (11+13+14+11)/4=12.25, so that model outputs are adjusted from [10, 11, 13, 40, 14, 11, 12, . . . ] to [10, 11, 13, 12.25, 14, 11, 12, . . . ]. In this example, the model output 220 for RSₜ₃ (e.g., {RSₜ₃, 12.25} may be logged and utilized for online and/or offline model training/adaptation.

Techniques described herein may enable efficient training of machine learning models used for beam prediction, while simultaneously reducing control signaling overhead used to perform model training. In particular, by configuring the UE 115-a with thresholds used for reporting inputs/outputs of a machine model to the network for offline training, techniques described herein may enable the UE 115-a to report model inputs/outputs only in cases where offline training may be expected or required. As such, techniques described herein may reduce control signaling overhead associated with offline training, reduce a frequency of offline training, and reduce a latency of beam prediction performed using machine learning models. Moreover, by configuring the UE 115-a with thresholds used for reporting inputs/outputs of a machine model to the network for offline training, techniques described herein may enable the UE 115-a to perform online training using model outputs with high confidence values that are expected to improve the efficiency and reliability of the machine learning model to perform future beam predictions.

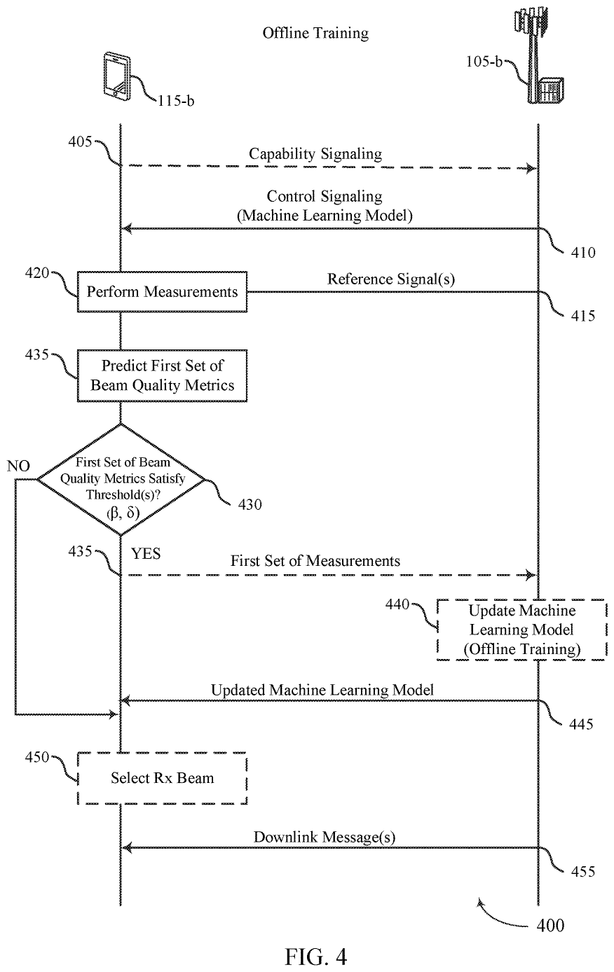

FIG. 4 illustrates an example of a process flow 400 that supports techniques for beam management using model adaptation in accordance with one or more aspects of the present disclosure. In some examples, aspects of the process flow 400 may implement, or be implemented by, aspects of wireless communications systems 100, the wireless communications system 200, the machine learning model configuration 300, or any combination thereof. For example, process flow 400 illustrates techniques for determining whether a UE 115-b will report measurements for offline model training, as described previously herein.

The process flow 400 includes a UE 115-b and a network entity 105-b, which may be examples of wireless devices as described herein. For example, the UE 115-b and the network entity 105-b illustrated in FIG. 4 may include examples of the UE 115-a and the network entity 105-a, respectively, as illustrated in FIG. 2.

In some examples, the operations illustrated in process flow 400 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 405, the UE 115-b may transmit capability signaling to the network entity 105-b. The capability signaling may indicate one or more capabilities associated with the ability of the UE 115-b to perform future beam predictions, such as supported machine learning models, processing capabilities, memory capabilities, and the like. For example, the capability signaling may indicate one or more machine learning models usable for performing beam predictions that are supported by the UE 115-b.

At 410, the UE 115-b may receive, from the network entity 105-b, control signaling indicating a machine learning model to be used for beam prediction at the UE 115-b. For example, the control signaling may indicate a machine learning model that is supported by the UE 115-b, as indicated via the capability signaling at 405. In this regard, the network entity 105-b may indicate what inputs are to be used for the machine learning model, and what outputs for beam prediction are to be predicted by the UE 115-b using the machine learning model.

In some aspects, the control signaling may additionally indicate one or more thresholds for reporting outputs from the machine learning model. For example, as described herein, the control signaling may indicate the thresholds β and/or δ that are used by the UE 115-b for determining if/when the UE 115-b is expected to report outputs from the machine learning model to the network for offline training.

At 415, the network entity 105-b may transmit a set of reference signals (e.g., SSBs) to the UE 115-b. The network entity 105-b may transmit reference signals that will be used by the UE 115-b for estimating channel conditions and performing beam predictions. In this regard, the network entity 105-b may transmit the reference signals at 415 based on receiving the capability signaling at 405, transmitting the control signaling at 410, or both.

In some aspects, the UE 115-b may receive the reference signals using one or more Rx beams at the UE 115-b. For example, the UE 115-b may scan through a set of Rx beams (e.g., Rx beam 1, Rx beam 2, Rx beam 3, etc.) to receive the respective reference signals in order to evaluate a relative performance or efficiency of the respective Rx beams for receiving communications from the network entity 105-b.

At 420, the UE 115-b may perform a set of measurements on the set of reference signals received at 415. For example, in cases where the UE 115-b receives the reference signals with a set of Rx beams including a first Rx beam, a second Rx beam, and a third Rx beam, the UE 115-b may perform measurements for each of the first, second, and third Rx beams. Additionally, or alternatively, the UE 115-b may perform measurements using the same Rx beam(s) at different points in time. For example, the network entity 105-b may transmit reference signals within a first time interval (T₁), a second time interval (T₂), a third time interval (T₃). In this example, the UE 115-b may receive the reference signals using the same Rx beam (or set of Rx beams) for each of the respective time intervals, and may therefore perform measurements to evaluate the relative performance of the Rx beam(s) over time.

The first set of measurements may include, but are not limited to, RSRP, RSRQ, SNR, SINR, CQI, RSSI, or any combination thereof. In some cases, the measurements performed by the UE 115-b may be based on what input(s) are to be used by the machine learning model for beam prediction. In this regard, the UE 115-b may perform the set of measurements at 420 based on transmitting the capability signaling at 405, receiving the control signaling at 410, receiving the reference signals at 415, or any combination thereof.

At 435, the UE 115-b may predict a first set of beam quality metrics associated with Rx beam(s) at the UE 115-b based on inputting the first set of measurements into the machine learning model. The first set of beam quality metrics may include predicted metrics associated with the Rx beam(s) for one or more time intervals in the future. In some cases, the Rx beam(s) associated with the outputs/predictions of the machine learning model may be the same or different compared to the Rx beam(s) used to receive the reference signals at 415.

As described previously herein, the first set of beam quality metrics may include multiple different types of beam quality metrics. For example, as shown and described with reference to FIG. 3, the first set of beam quality metrics may include a set of probability metrics (e.g., confidential probability vector 320) indicating a relative probability that corresponding beams of the set of Rx beams satisfy a threshold beam performance. In additional or alternative implementations, the set of beam quality metrics may include predicted RSRP values, RSRQ values, SNR values, SINR values, CQI values, RSSI values, or any combination thereof.

The UE 115-b may additionally be configured to predict, using the machine learning model, a set of beam indices corresponding to the first set of beam quality metrics. For example, as shown and described with reference to FIG. 3, the UE 115-b may predict, using the machine learning model, a set of beam indices (e.g., beam prediction vector 325) corresponding to the first set of beam quality metrics (e.g., confidential probability vector 320).

At 430, the UE 115-b may determine whether the first set of beam quality metrics (e.g., RSRP values, probability metrics) satisfy the one or more thresholds for reporting model outputs. In this regard, the UE 115-b may perform the determination at 430 based on transmitting the capability signaling at 405, receiving the control signaling at 410, receiving the reference signals at 415, performing the measurements at 420, predicting the first set of beam quality metrics at 425, or any combination thereof.

The threshold (e.g., β and/or δ) used to perform the determination at 430 may be based on the type of beam quality metrics predicted at 425. For example, in cases where the first set of beam quality metrics include predicted probability metrics (e.g., confidential probability vector 320), the UE 115-b may compare the predicted probability metrics to a confidence/probability threshold β. In this example, the first set of beam quality metrics may satisfy the threshold β if all the probability metrics (e.g., all the values of the confidential probability vector 320) are less than or equal to the threshold β (e.g., threshold satisfied if all probability metrics≤β). In such cases where the threshold β is satisfied, this may indicate that the outputs of the machine learning model are associated with relatively low confidence values, and that the inputs and/or outputs should be reported to the network for offline training.

By way of another example, in cases where the first set of beam quality metrics include predicted RSRP measurements associated with the set of Rx beams, the UE 115-b may compare the predicted RSRP measurements to actual RSRP measurements predicted using mathematical operations different from the machine learning model (e.g., traditional algorithms), and may compare the difference between the predicted RSRP measurements to a threshold RSRP metric (δ).

For instance, the first set of beam quality metrics may include predicted RSRP measurements associated with the set of Rx beams predicted by the machine learning model. In this example, the UE 115-b may perform a second set of measurements using non-machine learning-based techniques (e.g., traditional algorithms). The UE 115-b may then determine differences (e.g., MMSE metrics) between the first set of RSRP measurements (RSRP₁) predicted by the machine learning model, and the second set of RSRP measurements (RSRP₂) predicted by non-machine learning-based algorithms. In this example, the first set of beam quality metrics (e.g., first set of RSRP measurements) predicted by the model may satisfy a threshold RSRP metric (δ) if one or more differences between the first set of RSRP measurements (RSRP₁) and the second set of RSRP measurements (RSRP₂) is greater than or equal to the threshold RSRP metric (δ) (e.g., threshold RSRP metric δ satisfied if |RSRP₁−RSRP₂|≥δ). In such cases where the threshold δ is satisfied, this may indicate that the outputs of the machine learning model deviate significantly from what would be predicted using non-machine learning-based algorithms, and that the inputs and/or outputs should be reported to the network for offline training.

In cases where the first set of beam quality metrics predicted at 425 fail to satisfy the one or more thresholds (e.g., β, δ) at 430 (e.g., step 430=“NO”), the process flow 400 may proceed to 450. In other words, if the first set of beam quality metrics fail to satisfy the threshold for reporting outputs of the machine learning model, the UE 115-b may refrain from reporting the measurements (inputs) and/or outputs from the model.

Comparatively, in cases where the first set of beam quality metrics predicted at 425 satisfy the one or more thresholds (e.g., β, δ) at 430 (e.g., step 430=“YES”), the process flow 400 may proceed to 435.

At 435, the UE 115-b may transmit a control message to the network entity 105-b, where the control message indicates the first set of measurements input to machine learning model. In this regard, in cases where the thresholds are satisfied at 430, the UE 115-b may report the measurements input into the machine learning model sot that the network may utilize the measurements to perform offline training for the machine learning model. In some cases, the control message may additionally indicate the first set of beam quality metrics output/predicted by the machine learning model.

At 440, the network entity 105-b may utilize the information reported at 435 to further train and update the machine learning model (e.g., offline training). For example, the network entity 105-b may input the measurements and/or first set of beam quality metrics into the machine learning model in order to perform offline training.

At 445, the UE 115-b may receive, from the network entity 105-b, control signaling indicating an updated version of the machine learning model. In this regard, the UE 115-b may receive an updated version of the machine learning model that is to be used for beam prediction going forward. The UE 115-b may receive the control signaling at 445 based on transmitting the measurements and/or model outputs to the network entity 105-b at 435.

At 450, the UE 115-b may select one or more Rx beams at the UE 115-b that will be used for receiving communications from the network entity 105-b. For example, as shown and describe in FIG. 3, the UE 115-b may select an Rx beam that is associated with the highest probability metric/confidence value, the highest RSRP value, and the like. In cases where the UE 115-b receives an updated machine learning model at 445, the UE 115-b may be configured to utilize the updated machine learning model to predict additional beam quality metrics, and may select the one or more Rx beams at 450 based on the additional beam quality metrics predicted via the updated machine learning model.

At 455, the UE 115-b may receive one or more messages (e.g., PDSCH messages, PDCCH messages) from the network entity 105-b. In particular, the UE 115-b may receive the one or more messages at 445 using the one or more Rx beams that were selected at 450.

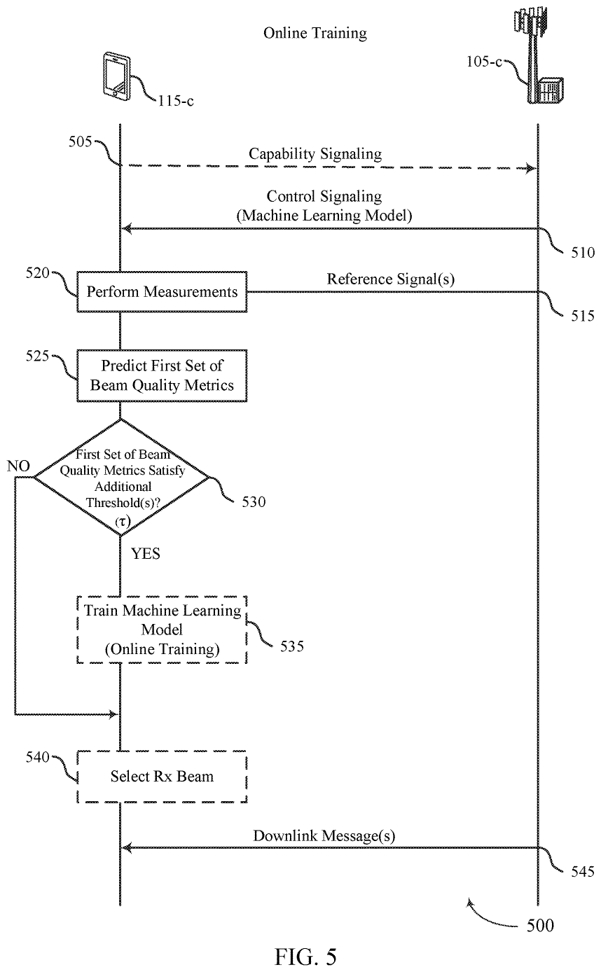

FIG. 5 illustrates an example of a process flow 500 that supports techniques for beam management using model adaptation in accordance with one or more aspects of the present disclosure. In some examples, aspects of the process flow 500 may implement, or be implemented by, aspects of wireless communications systems 100, the wireless communications system 200, the machine learning model configuration 300, the process flow 400, or any combination thereof. For example, process flow 500 illustrates techniques for determining which model outputs will be used for online model training, as described previously herein.

The process flow 500 includes a UE 115-c and a network entity 105-c, which may be examples of wireless devices as described herein. For example, the UE 115-c and the network entity 105-c illustrated in FIG. 5 may include examples of the UE 115-a and the network entity 105-a, respectively, as illustrated in FIG. 2.

In some examples, the operations illustrated in process flow 500 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 505, the UE 115-c may transmit capability signaling to the network entity 105-c. The capability signaling may indicate one or more capabilities associated with the ability of the UE 115-c to perform future beam predictions, such as supported machine learning models, processing capabilities, memory capabilities, and the like. For example, the capability signaling may indicate one or more machine learning models usable for performing beam predictions that are supported by the UE 115-c.

At 510, the UE 115-c may receive, from the network entity 105-c, control signaling indicating a machine learning model to be used for beam prediction at the UE 115-c. For example, the control signaling may indicate a machine learning model that is supported by the UE 115-c, as indicated via the capability signaling at 505. In this regard, the network entity 105-c may indicate what inputs are to be used for the machine learning model, and what outputs for beam prediction are to be predicted by the UE 115-c using the machine learning model.

In some aspects, the control signaling may additionally indicate one or more thresholds for performing online model training at the UE 115-c. For example, as described herein, the control signaling may indicate the threshold t that is used by the UE 115-c for determining if/when the UE 115-c may utilize inputs/outputs of the machine learning model for online model training at the UE 115-c.

At 515, the network entity 105-c may transmit a set of reference signals (e.g., SSBs) to the UE 115-c. The network entity 105-c may transmit reference signals that will be used by the UE 115-c for estimating channel conditions and performing beam predictions. In this regard, the network entity 105-c may transmit the reference signals at 515 based on receiving the capability signaling at 505, transmitting the control signaling at 510, or both.

In some aspects, the UE 115-c may receive the reference signals using one or more Rx beams at the UE 115-c. For example, the UE 115-c may scan through a set of Rx beams (e.g., Rx beam 1, Rx beam 2, Rx beam 3, etc.) to receive the respective reference signals in order to evaluate a relative performance or efficiency of the respective Rx beams for receiving communications from the network entity 105-c.

At 520, the UE 115-c may perform a set of measurements on the set of reference signals received at 515. For example, in cases where the UE 115-c receives the reference signals with a set of Rx beams including a first Rx beam, a second Rx beam, and a third Rx beam, the UE 115-c may perform measurements for each of the first, second, and third Rx beams. Additionally, or alternatively, the UE 115-c may perform measurements using the same Rx beam(s) at different points in time. For example, the network entity 105-c may transmit reference signals within a first time interval (T₁), a second time interval (T₂), a third time interval (T₃). In this example, the UE 115-c may receive the reference signals using the same Rx beam (or set of Rx beams) for each of the respective time intervals, and may therefore perform measurements to evaluate the relative performance of the Rx beam(s) over time.

The first set of measurements may include, but are not limited to, RSRP, RSRQ, SNR, SINR, CQI, RSSI, or any combination thereof. In some cases, the measurements performed by the UE 115-c may be based on what input(s) are to be used by the machine learning model for beam prediction. In this regard, the UE 115-c may perform the set of measurements at 520 based on transmitting the capability signaling at 505, receiving the control signaling at 510, receiving the reference signals at 515, or any combination thereof.

At 435, the UE 115-c may predict a first set of beam quality metrics associated with Rx beam(s) at the UE 115-c based on inputting the first set of measurements into the machine learning model. The first set of beam quality metrics may include predicted metrics associated with the Rx beam(s) for one or more time intervals in the future. In some cases, the Rx beam(s) associated with the outputs/predictions of the machine learning model may be the same or different compared to the Rx beam(s) used to receive the reference signals at 515.

As described previously herein, the first set of beam quality metrics may include multiple different types of beam quality metrics. For example, as shown and described with reference to FIG. 3, the first set of beam quality metrics may include a set of probability metrics (e.g., confidential probability vector 320) indicating a relative probability that corresponding beams of the set of Rx beams satisfy a threshold beam performance. In additional or alternative implementations, the set of beam quality metrics may include predicted RSRP values, RSRQ values, SNR values, SINR values, CQI values, RSSI values, or any combination thereof.

The UE 115-c may additionally be configured to predict, using the machine learning model, a set of beam indices corresponding to the first set of beam quality metrics. For example, as shown and described with reference to FIG. 3, the UE 115-c may predict, using the machine learning model, a set of beam indices (e.g., beam prediction vector 325) corresponding to the first set of beam quality metrics (e.g., confidential probability vector 320).

At 530, the UE 115-c may determine whether the first set of beam quality metrics (e.g., probability metrics) satisfy the one or more thresholds for reporting model outputs. In this regard, the UE 115-c may perform the determination at 530 based on transmitting the capability signaling at 505, receiving the control signaling at 510, receiving the reference signals at 515, performing the measurements at 520, predicting the first set of beam quality metrics at 525, or any combination thereof.

For example, in cases where the first set of beam quality metrics include predicted probability metrics (e.g., confidential probability vector 320), the UE 115-c may compare the predicted probability metrics to a confidence/probability threshold τ. In this example, the beam quality metrics of the first set of beam quality metrics which are greater than or equal to the threshold t may satisfy the threshold (e.g., threshold τ satisfied if probability metrics≥τ). In such cases where the threshold τ is satisfied, this may indicate that the corresponding outputs of the machine learning model are associated with relatively high confidence values, and may therefore be used to further train the model using online training.

In some cases, the UE 115-c may generate pseudo labels for beam quality metrics of the first set of beam quality metrics which satisfy the threshold τ. For example, the prediction/output with the highest probability metric/confidence value (e.g., highest of the confidential probability vector 320) may be set as a pseudo label.

In cases where the first set of beam quality metrics predicted at 325 fail to satisfy the one or more thresholds (e.g., τ) at 530 (e.g., step 530=“NO”), the process flow 500 may proceed to 540. In other words, if the first set of beam quality metrics fail to satisfy the threshold for online training, the UE 115-c may refrain from using the outputs and corresponding measurements to perform online training.

Comparatively, in cases where at least one beam quality metric of the first set of beam quality metrics predicted at 525 satisfy the one or more thresholds (e.g., τ) at 530 (e.g., step 530=“YES”), the process flow 500 may proceed to 435.

At 535, the UE 115-c may perform online training for the machine learning model by inputting the beam quality metrics which satisfy the threshold τ into the machine learning model. Additionally, the UE 115-b may input the corresponding measurements inputted into the model and/or generated pseudo labels into the machine learning model to perform online training.

At 540, the UE 115-c may select one or more Rx beams at the UE 115-c that will be used for receiving communications from the network entity 105-c. For example, as shown and describe in FIG. 3, the UE 115-c may select an Rx beam that is associated with the highest probability metric/confidence value, the highest RSRP value, and the like. In cases where the UE 115-c performs online training at 535 to update the machine learning model, the UE 115-c may be configured to utilize the updated machine learning model to predict additional beam quality metrics, and may select the one or more Rx beams at 540 based on the additional beam quality metrics predicted via the updated machine learning model.

At 545, the UE 115-c may receive one or more messages (e.g., PDSCH messages, PDCCH messages) from the network entity 105-c. In particular, the UE 115-b may receive the one or more messages at 545 using the one or more Rx beams that were selected at 540.

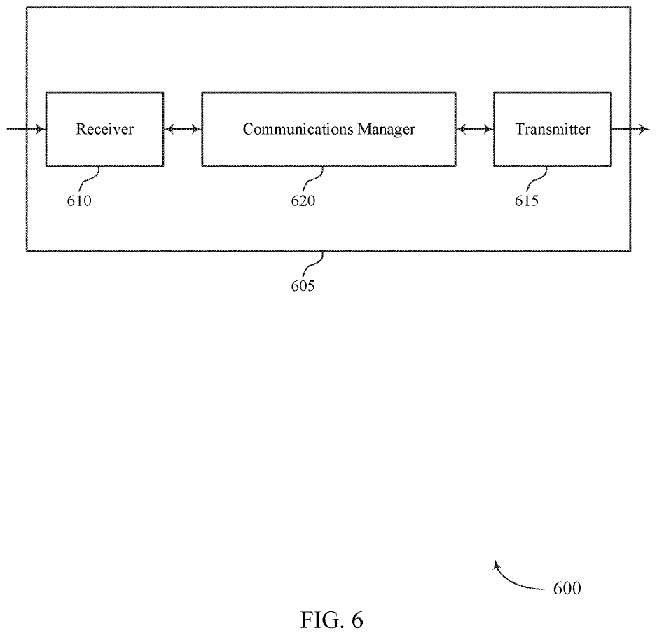

FIG. 6 illustrates a block diagram 600 of a device 605 that supports techniques for beam management using model adaptation in accordance with one or more aspects of the present disclosure. The device 605 may be an example of aspects of a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations thereof or various components thereof may be examples of means for performing various aspects of techniques for beam management using model adaptation as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

For example, the communications manager 620 may be configured as or otherwise support a means for receiving, from a network entity, control signaling indicating a machine learning model to be used for beam prediction at the UE, the control signaling further indicating one or more thresholds for reporting outputs from the machine learning model. The communications manager 620 may be configured as or otherwise support a means for performing a first set of measurements on a set of reference signals received from the network entity. The communications manager 620 may be configured as or otherwise support a means for predicting a first set of beam quality metrics associated with a set of Rx beams at the UE based on inputting the first set of measurements into the machine learning model. The communications manager 620 may be configured as or otherwise support a means for transmitting, to the network entity, a control message indicating the first set of measurements based on the first set of beam quality metrics satisfying the one or more thresholds.

For example, the communications manager 620 may be configured as or otherwise support a means for transmitting, to a UE, control signaling indicating a machine learning model to be used for beam prediction at the UE, the control signaling further indicating one or more thresholds for reporting outputs from the machine learning model. The communications manager 620 may be configured as or otherwise support a means for transmitting a set of reference signals to the UE based on the control signaling. The communications manager 620 may be configured as or otherwise support a means for receiving, from the UE, a control message indicating a first set of measurements associated with the set of reference signals, where the control message is received based on a first set of beam quality metrics associated with the first set of measurements satisfying the one or more thresholds, where the first set of beam quality metrics include outputs of the machine learning model.

By including or configuring the communications manager 620 in accordance with examples as described herein, the device 605 (e.g., a processor controlling or otherwise coupled with the receiver 610, the transmitter 615, the communications manager 620, or a combination thereof) may support techniques that enable efficient training of machine learning models used for beam prediction, while simultaneously reducing control signaling overhead used to perform model training. In particular, by configuring UEs 115 with thresholds used for reporting inputs/outputs of a machine model to the network for offline training, techniques described herein may enable UEs 115 to report model inputs/outputs only in cases where offline training may be expected or required. As such, techniques described herein may reduce control signaling overhead associated with offline training, reduce a frequency of offline training, and reduce a latency of beam prediction performed using machine learning models. Moreover, by configuring UEs 115 with thresholds used for reporting inputs/outputs of a machine model to the network for offline training, techniques described herein may enable UEs 115 to perform online training using model outputs with high confidence values that are expected to improve the efficiency and reliability of the machine learning model to perform future beam predictions.

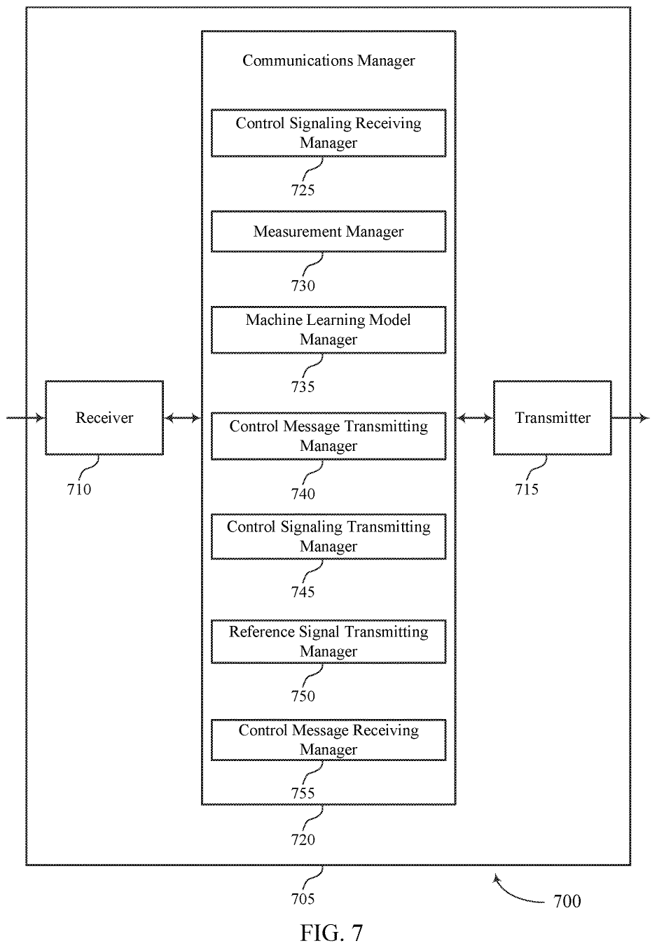

FIG. 7 illustrates a block diagram 700 of a device 705 that supports techniques for beam management using model adaptation in accordance with one or more aspects of the present disclosure. The device 705 may be an example of aspects of a device 605 or a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of techniques for beam management using model adaptation as described herein. For example, the communications manager 720 may include a control signaling receiving manager 725, a measurement manager 730, a machine learning model manager 735, a control message transmitting manager 740, a control signaling transmitting manager 745, a reference signal transmitting manager 750, a control message receiving manager 755, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The control signaling receiving manager 725 may be configured as or otherwise support a means for receiving, from a network entity, control signaling indicating a machine learning model to be used for beam prediction at the UE, the control signaling further indicating one or more thresholds for reporting outputs from the machine learning model. The measurement manager 730 may be configured as or otherwise support a means for performing a first set of measurements on a set of reference signals received from the network entity. The machine learning model manager 735 may be configured as or otherwise support a means for predicting a first set of beam quality metrics associated with a set of Rx beams at the UE based on inputting the first set of measurements into the machine learning model. The control message transmitting manager 740 may be configured as or otherwise support a means for transmitting, to the network entity, a control message indicating the first set of measurements based on the first set of beam quality metrics satisfying the one or more thresholds.

The control signaling transmitting manager 745 may be configured as or otherwise support a means for transmitting, to a UE, control signaling indicating a machine learning model to be used for beam prediction at the UE, the control signaling further indicating one or more thresholds for reporting outputs from the machine learning model. The reference signal transmitting manager 750 may be configured as or otherwise support a means for transmitting a set of reference signals to the UE based on the control signaling. The control message receiving manager 755 may be configured as or otherwise support a means for receiving, from the UE, a control message indicating a first set of measurements associated with the set of reference signals, where the control message is received based on a first set of beam quality metrics associated with the first set of measurements satisfying the one or more thresholds, where the first set of beam quality metrics include outputs of the machine learning model.

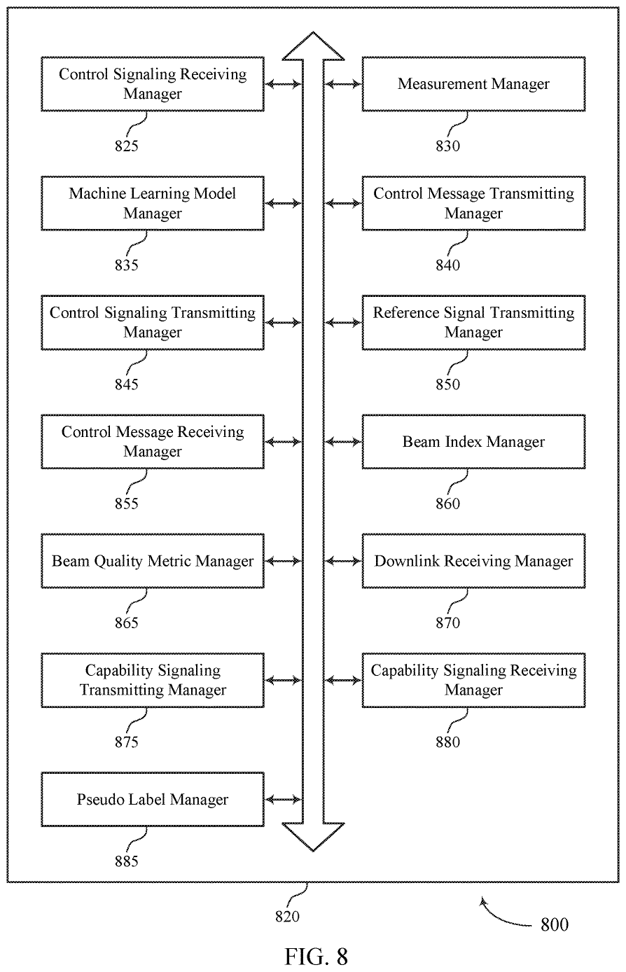

FIG. 8 illustrates a block diagram 800 of a communications manager 820 that supports techniques for beam management using model adaptation in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for beam management using model adaptation as described herein. For example, the communications manager 820 may include a control signaling receiving manager 825, a measurement manager 830, a machine learning model manager 835, a control message transmitting manager 840, a control signaling transmitting manager 845, a reference signal transmitting manager 850, a control message receiving manager 855, a beam index manager 860, a beam quality metric manager 865, a downlink receiving manager 870, a capability signaling transmitting manager 875, a capability signaling receiving manager 880, a pseudo label manager 885, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The control signaling receiving manager 825 may be configured as or otherwise support a means for receiving, from a network entity, control signaling indicating a machine learning model to be used for beam prediction at the UE, the control signaling further indicating one or more thresholds for reporting outputs from the machine learning model. The measurement manager 830 may be configured as or otherwise support a means for performing a first set of measurements on a set of reference signals received from the network entity. The machine learning model manager 835 may be configured as or otherwise support a means for predicting a first set of beam quality metrics associated with a set of Rx beams at the UE based on inputting the first set of measurements into the machine learning model. The control message transmitting manager 840 may be configured as or otherwise support a means for transmitting, to the network entity, a control message indicating the first set of measurements based on the first set of beam quality metrics satisfying the one or more thresholds.

In some examples, the control signaling receiving manager 825 may be configured as or otherwise support a means for receiving, from the network entity, additional control signaling indicating an updated version of the machine learning model, where the additional control signaling is received based on transmitting the control message.

In some examples, the first set of beam quality metrics include a set of probability metrics indicating a relative probability that corresponding beams of the set of Rx beams satisfy a threshold beam performance. In some examples, the first set of beam quality metrics satisfy the one or more thresholds based on each of the first set of beam quality metrics being less than the one or more thresholds.

In some examples, the measurement manager 830 may be configured as or otherwise support a means for performing a second set of measurements on a second set of reference signals received from the network entity. In some examples, the machine learning model manager 835 may be configured as or otherwise support a means for predicting a second set of beam quality metrics associated with the set of Rx beams based on the second set of measurements, where the first set of beam quality metrics satisfy the one or more thresholds based on one or more differences between the first set of beam quality metrics and the second set of beam quality metrics being greater than or equal to the one or more thresholds.

In some examples, the first set of beam quality metrics and the second set of beam quality metrics include predicted RSRP measurements associated with the set of Rx beams. In some examples, the one or more thresholds include a threshold RSRP metric. In some examples, the second set of beam quality metrics include RSRP metrics that are predicted using one or more mathematical operations different from the machine learning model. In some examples, the one or more differences between the first set of beam quality metrics and the second set of beam quality metrics include MMSE metrics.

In some examples, the measurement manager 830 may be configured as or otherwise support a means for performing a second set of measurements on a second set of reference signals received from the network entity. In some examples, the machine learning model manager 835 may be configured as or otherwise support a means for predicting a second set of beam quality metrics associated with the set of Rx beams based on inputting the second set of measurements into the machine learning model. In some examples, the machine learning model manager 835 may be configured as or otherwise support a means for training the machine learning model based using the second set of measurements based on at least one beam quality metric of the second set of beam quality metrics satisfying the one or more additional thresholds.

In some examples, the pseudo label manager 885 may be configured as or otherwise support a means for generating a pseudo label associated with the at least one beam quality metric of the second set of beam quality metrics that satisfies the one or more additional thresholds. In some examples, the machine learning model manager 835 may be configured as or otherwise support a means for inputting, into the machine learning model, the pseudo label, the at least one beam quality metric of the second set of beam quality metrics, and at least one measurement of the second set of measurements which corresponds to the at least one beam quality metric, where the training is based on the inputting.

In some examples, the second set of beam quality metrics include a set of probability metrics indicating a relative probability that corresponding beams of the set of Rx beams satisfy a threshold beam performance. In some examples, the at least one beam quality metric of the second set of beam quality metrics satisfies the one or more additional thresholds based on the at least one beam quality metric greater than or equal to the one or more additional thresholds.

In some examples, the machine learning model manager 835 may be configured as or otherwise support a means for predicting a first set of beam indices corresponding to the first set of beam quality metrics, the first set of beam indices indicating predicted Rx beams associated with a set of multiple time instances. In some examples, the beam index manager 860 may be configured as or otherwise support a means for selectively modifying a beam index of the first set of beam indices based on one or more differences between the beam index and one or more additional beam indices corresponding to one or more time instances of the set of multiple time instances within a consistence window.

In some examples, the control signaling receiving manager 825 may be configured as or otherwise support a means for receiving an indication of the consistence window via the control signaling, where selectively modifying the beam index is based on receiving the control signaling.

In some examples, the beam quality metric manager 865 may be configured as or otherwise support a means for selectively modifying at least one predicted beam quality metric of the set of multiple predicted beam quality metrics within the second time interval based on the at least one predicted beam quality metric satisfying an outlier threshold.

In some examples, the downlink receiving manager 870 may be configured as or otherwise support a means for selecting an Rx beam from the set of Rx beams based on the first set of beam quality metrics. In some examples, the downlink receiving manager 870 may be configured as or otherwise support a means for receiving one or more messages from the network entity using the Rx beam based on the selecting.

In some examples, the capability signaling transmitting manager 875 may be configured as or otherwise support a means for transmitting, to the network entity, capability signaling indicating one or more capabilities associated with the UE, where receiving the control signaling is based on the capability signaling.

In some examples, the measurement manager 830 may be configured as or otherwise support a means for performing a second set of measurements on a second set of reference signals received from the network entity. In some examples, the machine learning model manager 835 may be configured as or otherwise support a means for determining a second set of beam quality metrics associated with the set of Rx beams, an additional set of Rx beams, or both, based on inputting the second set of measurements into the machine learning model. In some examples, the control message transmitting manager 840 may be configured as or otherwise support a means for refraining from reporting the second set of measurements to the network entity based on at least one beam quality metric of the second set of beam quality metrics failing to satisfy the one or more thresholds.

The control signaling transmitting manager 845 may be configured as or otherwise support a means for transmitting, to a UE, control signaling indicating a machine learning model to be used for beam prediction at the UE, the control signaling further indicating one or more thresholds for reporting outputs from the machine learning model. The reference signal transmitting manager 850 may be configured as or otherwise support a means for transmitting a set of reference signals to the UE based on the control signaling. The control message receiving manager 855 may be configured as or otherwise support a means for receiving, from the UE, a control message indicating a first set of measurements associated with the set of reference signals, where the control message is received based on a first set of beam quality metrics associated with the first set of measurements satisfying the one or more thresholds, where the first set of beam quality metrics include outputs of the machine learning model.

In some examples, the machine learning model manager 835 may be configured as or otherwise support a means for training the machine learning model based on the first set of measurements, the first set of beam quality metrics, or both. In some examples, the control signaling transmitting manager 845 may be configured as or otherwise support a means for transmitting, to the UE, additional control signaling indicating an updated version of the machine learning model based on training the machine learning model.

In some examples, the first set of beam quality metrics include a set of probability metrics indicating a relative probability that corresponding beams of the set of Rx beams satisfy a threshold beam performance. In some examples, the first set of beam quality metrics satisfy the one or more thresholds based on each of the first set of beam quality metrics being less than the one or more thresholds.

In some examples, the first set of beam quality metrics satisfy the one or more thresholds based on one or more differences between the first set of beam quality metrics and a second set of beam quality metrics being greater than or equal to the one or more thresholds.

In some examples, the first set of beam quality metrics and the second set of beam quality metrics include predicted RSRP measurements associated with the set of Rx beams. In some examples, the one or more thresholds include a threshold RSRP metric. In some examples, the second set of beam quality metrics include RSRP metrics that are predicted using one or more mathematical operations different from the machine learning model. In some examples, the one or more differences between the first set of beam quality metrics and the second set of beam quality metrics include MMSE metrics.

In some examples, the control signaling further indicates one or more additional thresholds for training the machine learning model at the UE.

In some examples, the capability signaling receiving manager 880 may be configured as or otherwise support a means for receiving, from the UE, capability signaling indicating one or more capabilities associated with the UE, where transmitting the control signaling is based on the capability signaling.

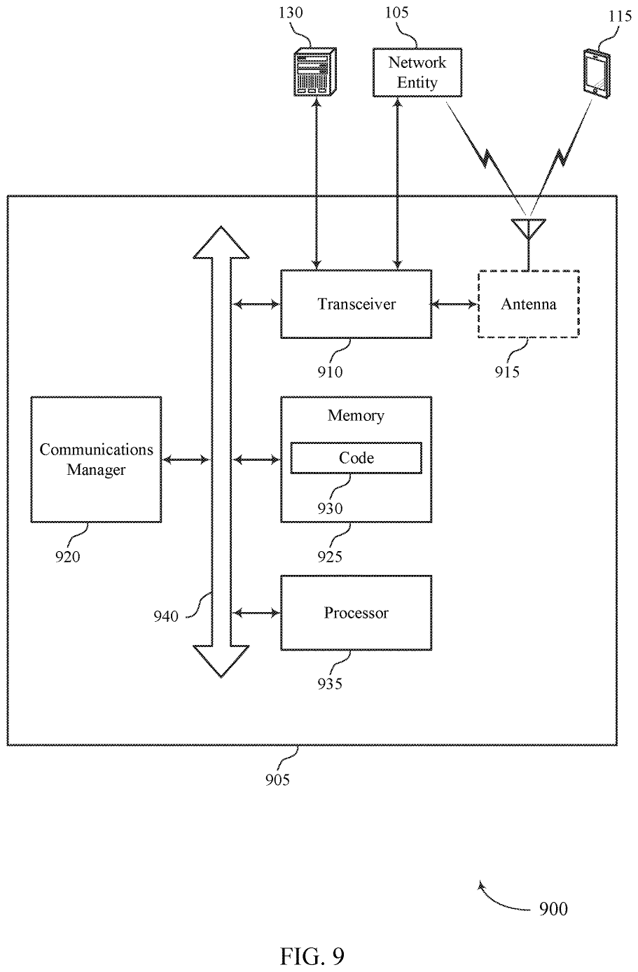

FIG. 9 illustrates a diagram of a system 900 including a device 905 that supports techniques for beam management using model adaptation in accordance with one or more aspects of the present disclosure. The device 905 may be an example of or include the components of a device 605, a device 705, or a network entity 105 as described herein. The device 905 may communicate with one or more network entities 105, one or more UEs 115, or any combination thereof, which may include communications over one or more wired interfaces, over one or more wireless interfaces, or any combination thereof. The device 905 may include components that support outputting and obtaining communications, such as a communications manager 920, a transceiver 910, an antenna 915, a memory 925, code 930, and a processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or memory components (for example, the processor 935, or the memory 925, or both), may be included in a chip or chip assembly that is installed in the device 905. In some examples, the transceiver may be operable to support communications via one or more communications links (e.g., a communication link 125, a backhaul communication link 120, a midhaul communication link 162, a fronthaul communication link 168).

The memory 925 may include RAM and ROM. The memory 925 may store computer-readable, computer-executable code 930 including instructions that, when executed by the processor 935, cause the device 905 to perform various functions described herein. The code 930 may be stored in a non-transitory computer-readable medium such as system memory or another type of memory. In some cases, the code 930 may not be directly executable by the processor 935 but may cause a computer (e.g., when compiled and executed) to perform functions described herein. In some cases, the memory 925 may contain, among other things, a BIOS which may control basic hardware or software operation such as the interaction with peripheral components or devices.

The processor 935 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 935 may be configured to operate a memory array using a memory controller. In some other cases, a memory controller may be integrated into the processor 935. The processor 935 may be configured to execute computer-readable instructions stored in a memory (e.g., the memory 925) to cause the device 905 to perform various functions (e.g., functions or tasks supporting techniques for beam management using model adaptation). For example, the device 905 or a component of the device 905 may include a processor 935 and memory 925 coupled with the processor 935, the processor 935 and memory 925 configured to perform various functions described herein. The processor 935 may be an example of a cloud-computing platform (e.g., one or more physical nodes and supporting software such as operating systems, virtual machines, or container instances) that may host the functions (e.g., by executing code 930) to perform the functions of the device 905. The processor 935 may be any one or more suitable processors capable of executing scripts or instructions of one or more software programs stored in the device 905 (such as within the memory 925). In some implementations, the processor 935 may be a component of a processing system. A processing system may generally refer to a system or series of machines or components that receives inputs and processes the inputs to produce a set of outputs (which may be passed to other systems or components of, for example, the device 905). For example, a processing system of the device 905 may refer to a system including the various other components or subcomponents of the device 905, such as the processor 935, or the transceiver 910, or the communications manager 920, or other components or combinations of components of the device 905.

The processing system of the device 905 may interface with other components of the device 905, and may process information received from other components (such as inputs or signals) or output information to other components. For example, a chip or modem of the device 905 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 905 may transmit information output from the chip or modem. Additionally, or alternatively, in some implementations, the one or more interfaces may refer to an interface between the processing system of the chip or modem and a receiver, such that the device 905 may obtain information or signal inputs, and the information may be passed to the processing system. A person having ordinary skill in the art will readily recognize that a first interface also may obtain information or signal inputs, and a second interface also may output information or signal outputs.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the memory 925, the code 930, and the processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with other network entities 105, and may include a controller or scheduler for controlling communications with UEs 115 in cooperation with other network entities 105. In some examples, the communications manager 920 may support an X2 interface within an LTE/LTE-A wireless communications network technology to provide communication between network entities 105.

For example, the communications manager 920 may be configured as or otherwise support a means for receiving, from a network entity, control signaling indicating a machine learning model to be used for beam prediction at the UE, the control signaling further indicating one or more thresholds for reporting outputs from the machine learning model. The communications manager 920 may be configured as or otherwise support a means for performing a first set of measurements on a set of reference signals received from the network entity. The communications manager 920 may be configured as or otherwise support a means for predicting a first set of beam quality metrics associated with a set of Rx beams at the UE based on inputting the first set of measurements into the machine learning model. The communications manager 920 may be configured as or otherwise support a means for transmitting, to the network entity, a control message indicating the first set of measurements based on the first set of beam quality metrics satisfying the one or more thresholds.

For example, the communications manager 920 may be configured as or otherwise support a means for transmitting, to a UE, control signaling indicating a machine learning model to be used for beam prediction at the UE, the control signaling further indicating one or more thresholds for reporting outputs from the machine learning model. The communications manager 920 may be configured as or otherwise support a means for transmitting a set of reference signals to the UE based on the control signaling. The communications manager 920 may be configured as or otherwise support a means for receiving, from the UE, a control message indicating a first set of measurements associated with the set of reference signals, where the control message is received based on a first set of beam quality metrics associated with the first set of measurements satisfying the one or more thresholds, where the first set of beam quality metrics include outputs of the machine learning model.

By including or configuring the communications manager 920 in accordance with examples as described herein, the device 905 may support techniques that enable efficient training of machine learning models used for beam prediction, while simultaneously reducing control signaling overhead used to perform model training. In particular, by configuring UEs 115 with thresholds used for reporting inputs/outputs of a machine model to the network for offline training, techniques described herein may enable UEs 115 to report model inputs/outputs only in cases where offline training may be expected or required. As such, techniques described herein may reduce control signaling overhead associated with offline training, reduce a frequency of offline training, and reduce a latency of beam prediction performed using machine learning models. Moreover, by configuring UEs 115 with thresholds used for reporting inputs/outputs of a machine model to the network for offline training, techniques described herein may enable UEs 115 to perform online training using model outputs with high confidence values that are expected to improve the efficiency and reliability of the machine learning model to perform future beam predictions.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the transceiver 910, the processor 935, the memory 925, the code 930, or any combination thereof. For example, the code 930 may include instructions executable by the processor 935 to cause the device 905 to perform various aspects of techniques for beam management using model adaptation as described herein, or the processor 935 and the memory 925 may be otherwise configured to perform or support such operations.

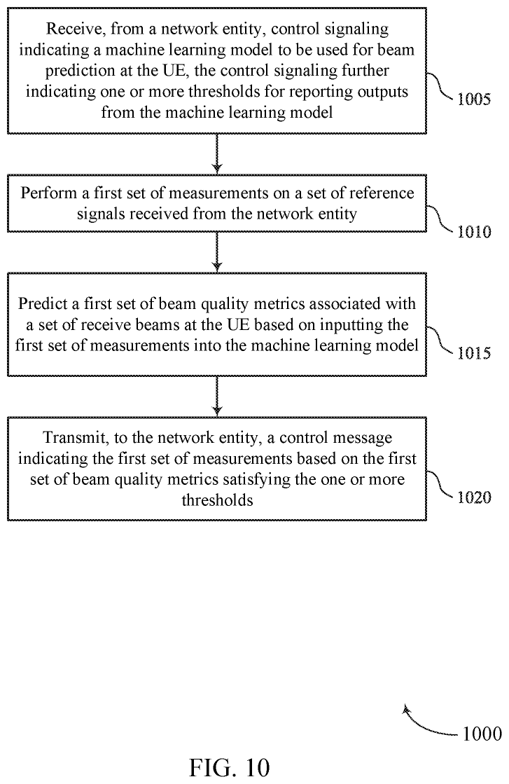

FIG. 10 illustrates a flowchart illustrating a method 1000 that supports techniques for beam management using model adaptation in accordance with one or more aspects of the present disclosure. The operations of the method 1000 may be implemented by a network entity or its components as described herein. For example, the operations of the method 1000 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1005, the method may include receiving, from a network entity, control signaling indicating a machine learning model to be used for beam prediction at the UE, the control signaling further indicating one or more thresholds for reporting outputs from the machine learning model. The operations of 1005 may be performed in accordance with examples as disclosed herein. In some examples, aspects of the operations of 1005 may be performed by a control signaling receiving manager 825 as described with reference to FIG. 8.

At 1010, the method may include performing a first set of measurements on a set of reference signals received from the network entity. The operations of 1010 may be performed in accordance with examples as disclosed herein. In some examples, aspects of the operations of 1010 may be performed by a measurement manager 830 as described with reference to FIG. 8.

At 1015, the method may include predicting a first set of beam quality metrics associated with a set of Rx beams at the UE based on inputting the first set of measurements into the machine learning model. The operations of 1015 may be performed in accordance with examples as disclosed herein. In some examples, aspects of the operations of 1015 may be performed by a machine learning model manager 835 as described with reference to FIG. 8.

At 1020, the method may include transmitting, to the network entity, a control message indicating the first set of measurements based on the first set of beam quality metrics satisfying the one or more thresholds. The operations of 1020 may be performed in accordance with examples as disclosed herein. In some examples, aspects of the operations of 1020 may be performed by a control message transmitting manager 840 as described with reference to FIG. 8.

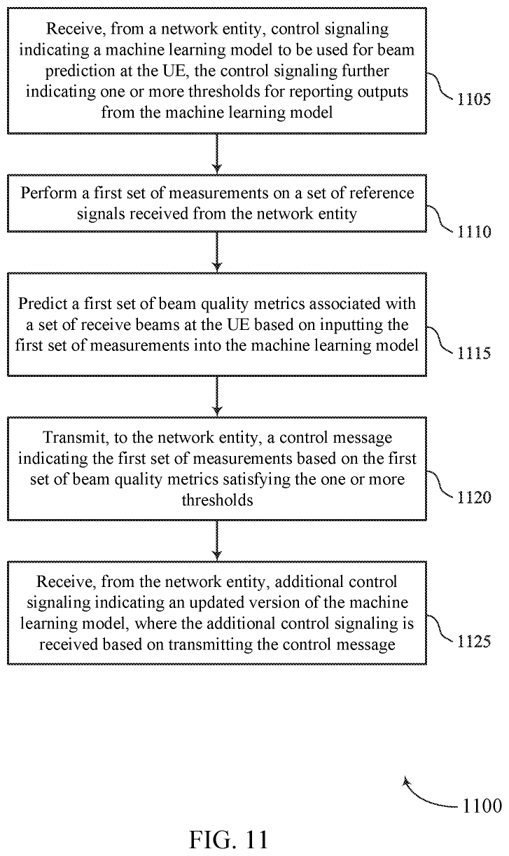

FIG. 11 illustrates a flowchart illustrating a method 1100 that supports techniques for beam management using model adaptation in accordance with one or more aspects of the present disclosure. The operations of the method 1100 may be implemented by a network entity or its components as described herein. For example, the operations of the method 1100 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1105, the method may include receiving, from a network entity, control signaling indicating a machine learning model to be used for beam prediction at the UE, the control signaling further indicating one or more thresholds for reporting outputs from the machine learning model. The operations of 1105 may be performed in accordance with examples as disclosed herein. In some examples, aspects of the operations of 1105 may be performed by a control signaling receiving manager 825 as described with reference to FIG. 8.

At 1110, the method may include performing a first set of measurements on a set of reference signals received from the network entity. The operations of 1110 may be performed in accordance with examples as disclosed herein. In some examples, aspects of the operations of 1110 may be performed by a measurement manager 830 as described with reference to FIG. 8.

At 1115, the method may include predicting a first set of beam quality metrics associated with a set of Rx beams at the UE based on inputting the first set of measurements into the machine learning model. The operations of 1115 may be performed in accordance with examples as disclosed herein. In some examples, aspects of the operations of 1115 may be performed by a machine learning model manager 835 as described with reference to FIG. 8.

At 1120, the method may include transmitting, to the network entity, a control message indicating the first set of measurements based on the first set of beam quality metrics satisfying the one or more thresholds. The operations of 1120 may be performed in accordance with examples as disclosed herein. In some examples, aspects of the operations of 1120 may be performed by a control message transmitting manager 840 as described with reference to FIG. 8.

At 1125, the method may include receiving, from the network entity, additional control signaling indicating an updated version of the machine learning model, where the additional control signaling is received based on transmitting the control message. The operations of 1125 may be performed in accordance with examples as disclosed herein. In some examples, aspects of the operations of 1125 may be performed by a control signaling receiving manager 825 as described with reference to FIG. 8.

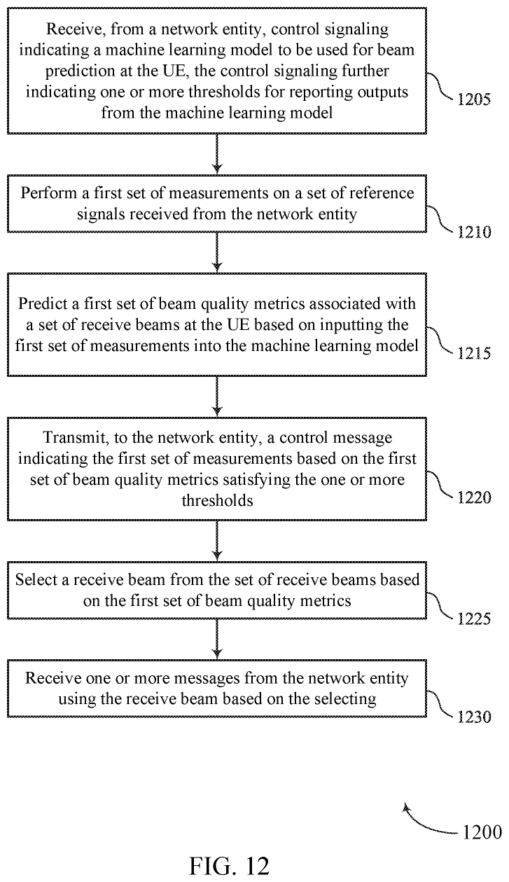

FIG. 12 illustrates a flowchart illustrating a method 1200 that supports techniques for beam management using model adaptation in accordance with one or more aspects of the present disclosure. The operations of the method 1200 may be implemented by a network entity or its components as described herein. For example, the operations of the method 1200 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1205, the method may include receiving, from a network entity, control signaling indicating a machine learning model to be used for beam prediction at the UE, the control signaling further indicating one or more thresholds for reporting outputs from the machine learning model. The operations of 1205 may be performed in accordance with examples as disclosed herein. In some examples, aspects of the operations of 1205 may be performed by a control signaling receiving manager 825 as described with reference to FIG. 8.

At 1210, the method may include performing a first set of measurements on a set of reference signals received from the network entity. The operations of 1210 may be performed in accordance with examples as disclosed herein. In some examples, aspects of the operations of 1210 may be performed by a measurement manager 830 as described with reference to FIG. 8.

At 1215, the method may include predicting a first set of beam quality metrics associated with a set of Rx beams at the UE based on inputting the first set of measurements into the machine learning model. The operations of 1215 may be performed in accordance with examples as disclosed herein. In some examples, aspects of the operations of 1215 may be performed by a machine learning model manager 835 as described with reference to FIG. 8.

At 1220, the method may include transmitting, to the network entity, a control message indicating the first set of measurements based on the first set of beam quality metrics satisfying the one or more thresholds. The operations of 1220 may be performed in accordance with examples as disclosed herein. In some examples, aspects of the operations of 1220 may be performed by a control message transmitting manager 840 as described with reference to FIG. 8.

At 1225, the method may include selecting an Rx beam from the set of Rx beams based on the first set of beam quality metrics. The operations of 1225 may be performed in accordance with examples as disclosed herein. In some examples, aspects of the operations of 1225 may be performed by a downlink receiving manager 870 as described with reference to FIG. 8.

At 1230, the method may include receiving one or more messages from the network entity using the Rx beam based on the selecting. The operations of 1230 may be performed in accordance with examples as disclosed herein. In some examples, aspects of the operations of 1230 may be performed by a downlink receiving manager 870 as described with reference to FIG. 8.

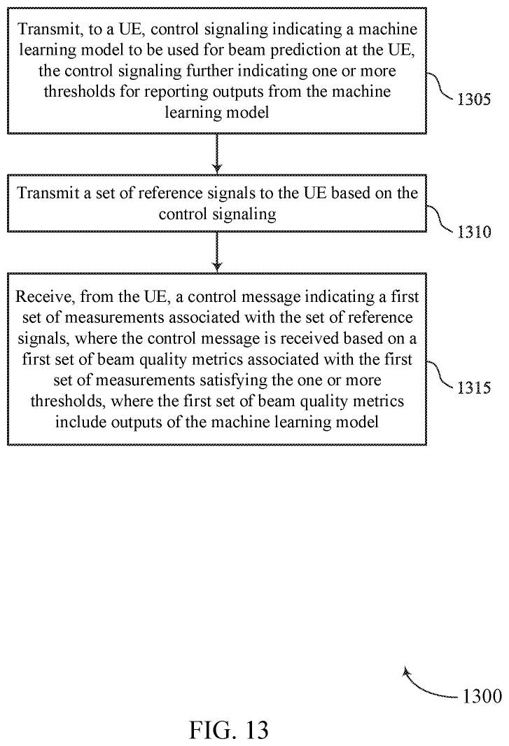

FIG. 13 illustrates a flowchart illustrating a method 1300 that supports techniques for beam management using model adaptation in accordance with one or more aspects of the present disclosure. The operations of the method 1300 may be implemented by a network entity or its components as described herein. For example, the operations of the method 1300 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1305, the method may include transmitting, to a UE, control signaling indicating a machine learning model to be used for beam prediction at the UE, the control signaling further indicating one or more thresholds for reporting outputs from the machine learning model. The operations of 1305 may be performed in accordance with examples as disclosed herein. In some examples, aspects of the operations of 1305 may be performed by a control signaling transmitting manager 845 as described with reference to FIG. 8.

At 1310, the method may include transmitting a set of reference signals to the UE based on the control signaling. The operations of 1310 may be performed in accordance with examples as disclosed herein. In some examples, aspects of the operations of 1310 may be performed by a reference signal transmitting manager 850 as described with reference to FIG. 8.

At 1315, the method may include receiving, from the UE, a control message indicating a first set of measurements associated with the set of reference signals, where the control message is received based on a first set of beam quality metrics associated with the first set of measurements satisfying the one or more thresholds, where the first set of beam quality metrics include outputs of the machine learning model. The operations of 1315 may be performed in accordance with examples as disclosed herein. In some examples, aspects of the operations of 1315 may be performed by a control message receiving manager 855 as described with reference to FIG. 8.

The following provides an overview of aspects of the present disclosure:

Aspect 1: A method for wireless communication at a UE, comprising: receiving, from a network entity, control signaling indicating a machine learning model to be used for beam prediction at the UE, the control signaling further indicating one or more thresholds for reporting outputs from the machine learning model; performing a first set of measurements on a set of reference signals received from the network entity; predicting a first set of beam quality metrics associated with a set of Rx beams at the UE based at least in part on inputting the first set of measurements into the machine learning model; and transmitting, to the network entity, a control message indicating the first set of measurements based at least in part on the first set of beam quality metrics satisfying the one or more thresholds.

Aspect 2: The method of aspect 1, further comprising: receiving, from the network entity, additional control signaling indicating an updated version of the machine learning model, wherein the additional control signaling is received based at least in part on transmitting the control message.

Aspect 3: The method of any of aspects 1 through 2, wherein the first set of beam quality metrics comprise a set of probability metrics indicating a relative probability that corresponding beams of the set of Rx beams satisfy a threshold beam performance, the first set of beam quality metrics satisfy the one or more thresholds based at least in part on each of the first set of beam quality metrics being less than the one or more thresholds.

Aspect 4: The method of any of aspects 1 through 3, further comprising: performing a second set of measurements on a second set of reference signals received from the network entity; and predicting a second set of beam quality metrics associated with the set of Rx beams based at least in part on the second set of measurements, wherein the first set of beam quality metrics satisfy the one or more thresholds based at least in part on one or more differences between the first set of beam quality metrics and the second set of beam quality metrics being greater than or equal to the one or more thresholds.

Aspect 5: The method of aspect 4, wherein the first set of beam quality metrics and the second set of beam quality metrics comprise predicted RSRP measurements associated with the set of Rx beams, and the one or more thresholds comprise a threshold RSRP metric.

Aspect 6: The method of any of aspects 4 through 5, wherein the second set of beam quality metrics comprise RSRP metrics that are predicted using one or more mathematical operations different from the machine learning model.

Aspect 7: The method of any of aspects 4 through 6, wherein the one or more differences between the first set of beam quality metrics and the second set of beam quality metrics comprise MMSE metrics.

Aspect 8: The method of any of aspects 1 through 7, wherein the control signaling further indicates one or more additional thresholds for training the machine learning model at the UE, the method further comprising: performing a second set of measurements on a second set of reference signals received from the network entity; predicting a second set of beam quality metrics associated with the set of Rx beams based at least in part on inputting the second set of measurements into the machine learning model; and training the machine learning model based using the second set of measurements based at least in part on at least one beam quality metric of the second set of beam quality metrics satisfying the one or more additional thresholds.

Aspect 9: The method of aspect 8, further comprising: generating a pseudo label associated with the at least one beam quality metric of the second set of beam quality metrics that satisfies the one or more additional thresholds; and inputting, into the machine learning model, the pseudo label, the at least one beam quality metric of the second set of beam quality metrics, and at least one measurement of the second set of measurements which corresponds to the at least one beam quality metric, wherein the training is based at least in part on the inputting.

Aspect 10: The method of any of aspects 8 through 9, wherein the second set of beam quality metrics comprise a set of probability metrics indicating a relative probability that corresponding beams of the set of Rx beams satisfy a threshold beam performance, the at least one beam quality metric of the second set of beam quality metrics satisfies the one or more additional thresholds based at least in part on the at least one beam quality metric greater than or equal to the one or more additional thresholds.

Aspect 11: The method of any of aspects 1 through 10, further comprising: predicting a first set of beam indices corresponding to the first set of beam quality metrics, the first set of beam indices indicating predicted Rx beams associated with a plurality of time instances; and selectively modifying a beam index of the first set of beam indices based at least in part on one or more differences between the beam index and one or more additional beam indices corresponding to one or more time instances of the plurality of time instances within a consistence window.

Aspect 12: The method of aspect 11, further comprising: receiving an indication of the consistence window via the control signaling, wherein selectively modifying the beam index is based at least in part on receiving the control signaling.

Aspect 13: The method of any of aspects 1 through 12, wherein the first set of measurements comprise a plurality of measurements performed on a plurality of reference signals received by the UE within a first time interval using an Rx beam of the set of Rx beams, and wherein the first set of beam quality metrics comprise a plurality of predicted beam quality metrics associated with the Rx beam within a second time interval, method further comprising: selectively modifying at least one predicted beam quality metric of the plurality of predicted beam quality metrics within the second time interval based at least in part on the at least one predicted beam quality metric satisfying an outlier threshold.

Aspect 14: The method of any of aspects 1 through 13, further comprising: selecting an Rx beam from the set of Rx beams based at least in part on the first set of beam quality metrics; and receiving one or more messages from the network entity using the Rx beam based at least in part on the selecting.

Aspect 15: The method of any of aspects 1 through 14, further comprising: transmitting, to the network entity, capability signaling indicating one or more capabilities associated with the UE, wherein receiving the control signaling is based at least in part on the capability signaling.

Aspect 16: The method of any of aspects 1 through 15, further comprising: performing a second set of measurements on a second set of reference signals received from the network entity; determining a second set of beam quality metrics associated with the set of Rx beams, an additional set of Rx beams, or both, based at least in part on inputting the second set of measurements into the machine learning model; and refraining from reporting the second set of measurements to the network entity based at least in part on at least one beam quality metric of the second set of beam quality metrics failing to satisfy the one or more thresholds.

Aspect 17: A method for wireless communication at a network entity, comprising: transmitting, to a UE, control signaling indicating a machine learning model to be used for beam prediction at the UE, the control signaling further indicating one or more thresholds for reporting outputs from the machine learning model; transmitting a set of reference signals to the UE based at least in part on the control signaling; and receiving, from the UE, a control message indicating a first set of measurements associated with the set of reference signals, wherein the control message is received based at least in part on a first set of beam quality metrics associated with the first set of measurements satisfying the one or more thresholds, wherein the first set of beam quality metrics comprise outputs of the machine learning model.

Aspect 18: The method of aspect 17, further comprising: training the machine learning model based at least in part on the first set of measurements, the first set of beam quality metrics, or both; and transmitting, to the UE, additional control signaling indicating an updated version of the machine learning model based at least in part on training the machine learning model.

Aspect 19: The method of any of aspects 17 through 18, wherein the first set of beam quality metrics comprise a set of probability metrics indicating a relative probability that corresponding beams of the set of Rx beams satisfy a threshold beam performance, the first set of beam quality metrics satisfy the one or more thresholds based at least in part on each of the first set of beam quality metrics being less than the one or more thresholds.

Aspect 20: The method of any of aspects 17 through 19, wherein the first set of beam quality metrics satisfy the one or more thresholds based at least in part on one or more differences between the first set of beam quality metrics and a second set of beam quality metrics being greater than or equal to the one or more thresholds.

Aspect 21: The method of aspect 20, wherein the first set of beam quality metrics and the second set of beam quality metrics comprise predicted RSRP measurements associated with the set of Rx beams, and the one or more thresholds comprise a threshold RSRP metric.

Aspect 22: The method of any of aspects 20 through 21, wherein the second set of beam quality metrics comprise RSRP metrics that are predicted using one or more mathematical operations different from the machine learning model.

Aspect 23: The method of any of aspects 20 through 22, wherein the one or more differences between the first set of beam quality metrics and the second set of beam quality metrics comprise MMSE metrics.

Aspect 24: The method of any of aspects 17 through 23, wherein the control signaling further indicates one or more additional thresholds for training the machine learning model at the UE.

Aspect 25: The method of any of aspects 17 through 24, further comprising: receiving, from the UE, capability signaling indicating one or more capabilities associated with the UE, wherein transmitting the control signaling is based at least in part on the capability signaling.

Aspect 26: An apparatus comprising a processor; memory coupled with the processor; and instructions stored in the memory and executable by the processor to cause the apparatus to perform a method of any of aspects 1 through 16.

Aspect 27: An apparatus comprising at least one means for performing a method of any of aspects 1 through 16.

Aspect 28: A non-transitory computer-readable medium storing code the code comprising instructions executable by a processor to perform a method of any of aspects 1 through 16.

Aspect 29: An apparatus comprising a processor; memory coupled with the processor; and instructions stored in the memory and executable by the processor to cause the apparatus to perform a method of any of aspects 17 through 25.

Aspect 30: An apparatus comprising at least one means for performing a method of any of aspects 17 through 25.

Aspect 31: A non-transitory computer-readable medium storing code the code comprising instructions executable by a processor to perform a method of any of aspects 17 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers.

Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor; and
a memory coupled with the processor, with instructions stored in the memory, the instructions being executable by the processor to cause the apparatus to:
receive, from a network entity, control signaling indicating a machine learning model to be used for beam prediction at the UE, the control signaling further indicating one or more thresholds for reporting outputs from the machine learning model;
perform a first set of measurements on a set of reference signals received from the network entity;
predict a first set of beam quality metrics associated with a set of receive beams at the UE based at least in part on inputting the first set of measurements into the machine learning model; and
transmit, to the network entity, a control message indicating the first set of measurements based at least in part on the first set of beam quality metrics satisfying the one or more thresholds.

2. The apparatus of claim 1, wherein the instructions are further executable by the processor to cause the apparatus to:
receive, from the network entity, additional control signaling indicating an updated version of the machine learning model, wherein the additional control signaling is received based at least in part on transmitting the control message.

3. The apparatus of claim 1, wherein the first set of beam quality metrics comprise a set of probability metrics indicating a relative probability that corresponding beams of the set of receive beams satisfy a threshold beam performance, wherein the first set of beam quality metrics satisfy the one or more thresholds based at least in part on each of the first set of beam quality metrics being less than the one or more thresholds.

4. The apparatus of claim 1, wherein the instructions are further executable by the processor to cause the apparatus to:
perform a second set of measurements on a second set of reference signals received from the network entity; and
predict a second set of beam quality metrics associated with the set of receive beams based at least in part on the second set of measurements, wherein the first set of beam quality metrics satisfy the one or more thresholds based at least in part on one or more differences between the first set of beam quality metrics and the second set of beam quality metrics being greater than or equal to the one or more thresholds.

5. The apparatus of claim 4, wherein the first set of beam quality metrics and the second set of beam quality metrics comprise predicted reference signal received power measurements associated with the set of receive beams, and wherein the one or more thresholds comprise a threshold reference signal received power metric.

6. The apparatus of claim 4, wherein the second set of beam quality metrics comprise reference signal received power metrics that are predicted using one or more mathematical operations different from the machine learning model.

7. The apparatus of claim 4, wherein the one or more differences between the first set of beam quality metrics and the second set of beam quality metrics comprise minimum mean square error metrics.

8. The apparatus of claim 1, wherein the control signaling further indicates one or more additional thresholds for training the machine learning model at the UE, wherein the instructions are further executable by the processor to cause the apparatus to:
perform a second set of measurements on a second set of reference signals received from the network entity;
predict a second set of beam quality metrics associated with the set of receive beams based at least in part on inputting the second set of measurements into the machine learning model; and
train the machine learning model based using the second set of measurements based at least in part on at least one beam quality metric of the second set of beam quality metrics satisfying the one or more additional thresholds.

9. The apparatus of claim 8, wherein the instructions are further executable by the processor to cause the apparatus to:
generate a pseudo label associated with the at least one beam quality metric of the second set of beam quality metrics that satisfies the one or more additional thresholds; and
input, into the machine learning model, the pseudo label, the at least one beam quality metric of the second set of beam quality metrics, and at least one measurement of the second set of measurements which corresponds to the at least one beam quality metric, wherein the training is based at least in part on the inputting.

10. The apparatus of claim 8, wherein the second set of beam quality metrics comprise a set of probability metrics indicating a relative probability that corresponding beams of the set of receive beams satisfy a threshold beam performance, wherein the at least one beam quality metric of the second set of beam quality metrics satisfies the one or more additional thresholds based at least in part on the at least one beam quality metric greater than or equal to the one or more additional thresholds.

11. The apparatus of claim 1, wherein the instructions are further executable by the processor to cause the apparatus to:
predict a first set of beam indices corresponding to the first set of beam quality metrics, the first set of beam indices indicating predicted receive beams associated with a plurality of time instances; and
selectively modify a beam index of the first set of beam indices based at least in part on one or more differences between the beam index and one or more additional beam indices corresponding to one or more time instances of the plurality of time instances within a consistence window.

12. The apparatus of claim 11, wherein the instructions are further executable by the processor to cause the apparatus to:
receive an indication of the consistence window via the control signaling, wherein selectively modifying the beam index is based at least in part on receiving the control signaling.

13. The apparatus of claim 1, wherein the first set of measurements comprise a plurality of measurements performed on a plurality of reference signals received by the UE within a first time interval using a receive beam of the set of receive beams, and wherein the first set of beam quality metrics comprise a plurality of predicted beam quality metrics associated with the receive beam within a second time interval, wherein the instructions are further executable by the processor to cause the apparatus to:
selectively modify at least one predicted beam quality metric of the plurality of predicted beam quality metrics within the second time interval based at least in part on the at least one predicted beam quality metric satisfying an outlier threshold.

14. The apparatus of claim 1, wherein the instructions are further executable by the processor to cause the apparatus to:
select a receive beam from the set of receive beams based at least in part on the first set of beam quality metrics; and
receive one or more messages from the network entity using the receive beam based at least in part on the selecting.

15. The apparatus of claim 1, wherein the instructions are further executable by the processor to cause the apparatus to:
transmit, to the network entity, capability signaling indicating one or more capabilities associated with the UE, wherein receiving the control signaling is based at least in part on the capability signaling.

16. The apparatus of claim 1, wherein the instructions are further executable by the processor to cause the apparatus to:
perform a second set of measurements on a second set of reference signals received from the network entity;
determine a second set of beam quality metrics associated with the set of receive beams, an additional set of receive beams, or both, based at least in part on inputting the second set of measurements into the machine learning model; and
refrain from reporting the second set of measurements to the network entity based at least in part on at least one beam quality metric of the second set of beam quality metrics failing to satisfy the one or more thresholds.

17-25. (canceled)

26. A method for wireless communication at a user equipment (UE), comprising:
receiving, from a network entity, control signaling indicating a machine learning model to be used for beam prediction at the UE, the control signaling further indicating one or more thresholds for reporting outputs from the machine learning model;
performing a first set of measurements on a set of reference signals received from the network entity;
predicting a first set of beam quality metrics associated with a set of receive beams at the UE based at least in part on inputting the first set of measurements into the machine learning model; and
transmitting, to the network entity, a control message indicating the first set of measurements based at least in part on the first set of beam quality metrics satisfying the one or more thresholds.

27. The method of claim 26, further comprising:
receiving, from the network entity, additional control signaling indicating an updated version of the machine learning model, wherein the additional control signaling is received based at least in part on transmitting the control message.

28. The method of claim 26, wherein the first set of beam quality metrics comprise a set of probability metrics indicating a relative probability that corresponding beams of the set of receive beams satisfy a threshold beam performance, wherein the first set of beam quality metrics satisfy the one or more thresholds based at least in part on each of the first set of beam quality metrics being less than the one or more thresholds.

29-30. (canceled)
